(19) United States
(12) Patent Application Publication
(10) Pub. No.: US 2025/0006207 A1
(43) Pub. Date: Jan. 2, 2025

(54) Systems and Methods For Steganographic Embedding of Metadata in Media

(71) Applicant: Google LLC, Mountain View, CA (US)

(72) Inventor: Matthew Sharifi, Kilchberg (CH)

(21) Appl. No.: 18/697,860

(22) PCT Filed: Oct. 12, 2021
(86) PCT No.: PCT/US2021/054550

§ 371 Date: Apr. 2, 2024

(51) Int. Cl. G10L 19/00; G06F 40/289; G10L 13/08

(52) U.S. Cl. CPC G10L 19/0018; G06F 40/289; G10L 13/08

(57) ABSTRACT

Systems and methods for steganographic embedding of metadata in media, and improved generation of synthetic media files. In some examples, a steganography encoder may be trained to encode a media file with data such that it will be more likely to be accurately decoded, and/or less likely to be perceptible to a user or other applications. In some examples, the media file may be a synthetically generated media file, and the data may be some or all of the data used to generate the synthetically generated media file. In some examples, a generative model may be trained to create synthetically generated media files that are more likely to be accurately interpreted by an interpretive model. In some examples, data encoded into a synthetically generated media file may be used to output an indication that the file was synthetically generated.

### BACKGROUND

Generative models can perform a wide array of tasks, including speech synthesis (text-to-speech or “TTS”), music generation, image generation, video generation, sound enhancement, image enhancement, video enhancement, text rendering, handwriting rendering, virtual avatar generation, and more. As the use of such models become more widespread, it may become desirable to embed metadata within the synthetic media (e.g., audio, images, video, rendered text) produced by such models to identify the media as having been synthetically generated and/or to leverage the information used to generate the media. In addition, as users interface with media through a growing variety of devices, applications, and transmission formats, it may be advantageous to embed metadata into media (both human-generated and synthetically generated media) to avoid the need to convert formatting of metadata and/or to prevent the metadata from becoming separated from the underlying media.

### BRIEF SUMMARY

In some aspects, the present technology concerns systems and methods for steganographic embedding of metadata in media. In that regard, there are many contexts in which it may be beneficial to embed metadata into synthetically generated media. For example, it may be desirable to use steganography to discreetly and/or indelibly identify the fact that the media is synthetic so that people will understand its source and/or authenticity. Likewise, it may be useful to mark such media so that it may be identified and excluded from use as training data for other machine-learning models.

The present technology may also be used to leverage the information used in creating synthetically generated media to simplify the processing of that media by other devices. For example, rather than using complex automatic speech recognition (“ASR”) models to identify the words spoken in a synthetically generated audio or video sample, the original text used to generate the speech may be encoded directly into the synthetically generated video or audio stream using steganography such that a simpler decoder may be used. Likewise, rather than using optical character recognition to recognize rendered text or generated handwriting, the original text used in generating the media may be embedded into the image including the rendered text or generated handwriting using steganography. These processes may reduce the computing resources required to analyze the media, and increase the speed at which such analysis may be undertaken.

The present technology may also leverage the information used to generate synthetic media for the purpose of tuning the output of a generative model. In this way, the generative model may be trained to generate content that is more likely to be decoded accurately by other models. Thus, for example, the original text used to generate a given sample of synthesized speech may be compared to the output of a known ASR model to generate a loss value on which the generative model can be trained. Such a loss value may be used to train (e.g., parameterize) the generative model to create synthetic speech that is more likely to be correctly interpreted by that ASR model, and/or to train the generative model to include steganographic hints (e.g., one or more words, a vector configured to amplify a given classification) in the synthetic speech to bias the ASR model toward the correct the interpretation of the speech. Providing such hints may reduce the data size of the synthetic speech as compared to embedding an entire transcript, for example.

Further, in some aspects of the technology, steganography may be used to embed important metadata into media to avoid the possibility that the metadata may be lost or unreadable by a given device or application. In that regard, as users interface with media through a growing variety of devices, applications, and transmission formats, media of all types (human-generated and model-generated) may need to be converted in ways that make it difficult or impossible to transmit metadata alongside the content. For example, a close-captioning data stream may need to be formatted differently for use by a TV application than for a messaging application, such that close-captioning data transmitted alongside the associated audio and video data will only be visible on some applications but not others. However, if the close-captioning data were instead to be embedded within the associated audio or video stream, separate close-captioning data would not be needed and all applications could use the same decoder to identify and display that data. Likewise, steganography may be used to embed relevant information into media to reduce the computing resources required to analyze the media and increase the speed at which such analysis may be undertaken. For example, where a file type or transmission protocol does not allow for close-captioning data to be provided in a formatted metadata field, the present technology may be used to embed that information into the media file so that it is not necessary to employ a complex ASR model to generate close-captioning data in real-time. Further, steganography may be used to embed relevant information into media beyond what can be included in the file type's existing metadata fields. For example, a system according to the present technology may be configured to use steganography to embed the subjects and landmarks used to generate a synthetic image into the image data itself, or to embed the scores, lyrics, and instruments used to generate synthetic music into the resulting audio data.

In one aspect, the disclosure describes a computer-implemented training method, comprising: (1) generating, using one or more processors of a processing system, a synthetically generated media file based at least in part on first data using a generative model; (2) encoding, using the one or more processors, second data into the synthetically generated media file using a steganography encoder to generate an encoded media file, the second data being based at least in part on the first data; (3) processing, using the one or more processors, the encoded media file using a steganography decoder to generate decoded data; (4) generating, using the one or more processors, an accuracy loss value based at least in part on the second data and the decoded data; and (5) modifying, using the one or more processors, one or both of: one or more parameters of the steganography encoder, based at least in part on the accuracy loss value; or one or more parameters of the steganography decoder, based at least in part on the accuracy loss value. In some aspects, the method further comprises: generating, using the one or more processors, a discriminative loss value based at least in part on processing the encoded media file using a discriminative model; and modifying, using the one or more processors, one or more parameters of the steganography encoder based at least in part on the discriminative loss value. In some aspects, the steganography encoder is a part of the generative model. In some aspects, the first data is a text sequence, the generative model is a text-to-speech model, and the synthetically generated media file is an audio file including synthesized speech generated by the text-to-speech model based at least in part on the text sequence. In some aspects, encoding the second data into the synthetically generated media file using the steganography encoder to generate the encoded media file comprises encoding the text sequence into the encoded media file. In some aspects, encoding the second data into the synthetically generated media file using the steganography encoder to generate the encoded media file comprises encoding a tokenized version of the text sequence into the encoded media file. In some aspects, encoding the second data into the synthetically generated media file using the steganography encoder to generate the encoded media file comprises encoding a vector embedding based on the text sequence into the encoded media file.

In another aspect, the disclosure describes a computer-implemented training method, comprising: generating, using one or more processors of a processing system, a synthetically generated media file based at least in part on first data using a generative model; encoding, using the one or more processors, second data into the synthetically generated media file using a steganography encoder to generate an encoded media file, the second data being based at least in part on the first data; generating, using the one or more processors, a discriminative loss value based at least in part on processing the encoded media file using a discriminative model; and modifying, using the one or more processors, one or more parameters of the steganography encoder based at least in part on the discriminative loss value. In some aspects, the first data is a text sequence, the generative model is a text-to-speech model, and the synthetically generated media file is an audio file including synthesized speech generated by the text-to-speech model based at least in part on the text sequence. In some aspects, encoding the second data into the synthetically generated media file using the steganography encoder to generate the encoded media file comprises encoding the text sequence into the encoded media file. In some aspects, encoding the second data into the synthetically generated media file using the steganography encoder to generate the encoded media file comprises encoding a tokenized version of the text sequence into the encoded media file. In some aspects, encoding the second data into the synthetically generated media file using the steganography encoder to generate the encoded media file comprises encoding a vector embedding based on the text sequence into the encoded media file.

In another aspect, the disclosure describes a computer-implemented training method, comprising: (1) encoding, using one or more processors of a processing system, first data into a media file using a steganography encoder to generate an encoded media file; (2) processing, using the one or more processors, the encoded media file using a steganography decoder to generate decoded data; (3) generating, using the one or more processors, an accuracy loss value based at least in part on the first data and the decoded data; and (4) modifying, using the one or more processors, one or both of: one or more parameters of the steganography encoder, based at least in part on the accuracy loss value; or one or more parameters of the steganography decoder, based at least in part on the accuracy loss value. In some aspects, the method further comprises: generating, using the one or more processors, a discriminative loss value based at least in part on processing the encoded media file using a discriminative model; and modifying, using the one or more processors, one or more parameters of the steganography encoder based at least in part on the discriminative loss value. In some aspects, the media file is a synthetically generated media file generated by a generative model. In some aspects, the media file was generated by the generative model based at least in part on the first data. In some aspects, the steganography encoder is a part of the generative model. In some aspects, the media file is an audio or video file containing speech. In some aspects, encoding the first data into the media file using the steganography encoder to generate the encoded media file comprises encoding a text sequence into the encoded media file, the text sequence including a transcript or a translation of at least a portion of the speech. In some aspects, encoding the first data into the media file using the steganography encoder to generate the encoded media file comprises encoding a tokenized version of a text sequence into the encoded media file, the text sequence including a transcript or a translation of at least a portion of the speech. In some aspects, encoding the first data into the media file using the steganography encoder to generate the encoded media file comprises encoding a vector embedding based on a text sequence into the encoded media file, the text sequence including a transcript or a translation of at least a portion of the speech.

In another aspect, the disclosure describes a computer-implemented training method, comprising: generating, using one or more processors of a processing system, a synthetically generated media file based at least in part on first data using a generative model; processing, using the one or more processors, the synthetically generated media file using an interpretive model to generate first interpreted data; generating, using the one or more processors, a first accuracy loss value based at least in part on the first data and the first interpreted data; and modifying, using the one or more processors, one or more parameters of the generative model based at least in part on the first accuracy loss value. In some aspects, the first data is a text sequence, the generative model is a text-to-speech model, the synthetically generated media file is an audio file including synthesized speech generated by the text-to-speech model based at least in part on the text sequence, and the interpretive model is an automatic speech recognition model. In some aspects, the method further comprises: identifying, using the one or more processors, a difference between the first data and the first interpreted data; encoding, using the one or more processors, second data into the synthetically generated media file using a steganography encoder to generate an encoded media file, the second data being based at least in part on the identified difference; processing, using the one or more processors, the encoded media file using the interpretive model to generate second interpreted data; generating, using the one or more processors, a second accuracy loss value based at least in part on the first data and the second interpreted data; and modifying, using the one or more processors, one or more parameters of the steganography encoder based at least in part on the first accuracy loss value and the second accuracy loss value. In some aspects, the method further comprises: modifying, using the one or more processors, one or more parameters of the generative model based at least in part on the first accuracy loss value and the second accuracy loss value. In some aspects, the steganography encoder is a part of the generative model. In some aspects, the first data is a first text sequence, the first interpreted data is a second text sequence, and the identified difference comprises one or more words or characters that differ between the first text sequence and the second text sequence. In some aspects, encoding the second data into the synthetically generated media file using the steganography encoder to generate the encoded media file comprises encoding the one or more words or characters into the encoded media file. In some aspects, encoding the second data into the synthetically generated media file using the steganography encoder to generate the encoded media file comprises encoding a tokenized version of the one or more words or characters into the encoded media file. In some aspects, encoding the second data into the synthetically generated media file using the steganography encoder to generate the encoded media file comprises encoding a vector embedding based on the one or more words into the encoded media file.

In another aspect, the disclosure describes a computer-implemented method of outputting a media file, comprising: processing, using one or more processors of a processing system, an encoded media file using a steganography decoder to generate decoded data; outputting, using the one or more processors, media content of the encoded media file; determining, using the one or more processors, based on the decoded data, whether the media content of the encoded media file was generated by a generative model; and based on the determination, outputting, using the one or more processors, an indication of whether the encoded media file was generated by a generative model. In some aspects, outputting the indication of whether the encoded media file was generated by a generative model is performed in response to receiving an input from a user. In some aspects, the method further comprises outputting, using the one or more processors, the decoded data. In some aspects, the media file was generated by a generative model based at least in part on the decoded data. In some aspects, outputting the decoded data is performed in response to receiving an input from a user.

In another aspect, the disclosure describes a computer-implemented media generation method, comprising: generating, using one or more processors of a processing system, a synthetically generated media file based at least in part on first data using a generative model; and encoding, using the one or more processors, second data into the synthetically generated media file using a steganography encoder to generate an encoded media file, the second data being based at least in part on the first data. In some aspects, the steganography encoder is a part of the generative model. In some aspects, the first data is a text sequence, the generative model is a text-to-speech model, and the synthetically generated media file is an audio file including synthesized speech generated by the text-to-speech model based at least in part on the text sequence. In some aspects, encoding the second data into the synthetically generated media file using the steganography encoder to generate the encoded media file comprises encoding one or more words of the text sequence into the encoded media file. In some aspects, encoding the second data into the synthetically generated media file using the steganography encoder to generate the encoded media file comprises encoding a tokenized version of one or more words of the text sequence into the encoded media file. In some aspects, encoding the second data into the synthetically generated media file using the steganography encoder to generate the encoded media file comprises encoding a vector embedding based on one or more words of the text sequence into the encoded media file. In some aspects, encoding the second data into the synthetically generated media file using the steganography encoder to generate the encoded media file comprises encoding a vector into the encoded media file, the vector representing a classification generated by an interpretive model based on the text sequence.

In another aspect, the disclosure describes a processing system comprising: (A) a memory storing a generative model, a steganography encoder, and a steganography decoder; and (B) one or more processors coupled to the memory and configured to train one or both of the steganography encoder or the steganography encoder, comprising: (1) generating a synthetically generated media file based at least in part on first data using the generative model; (2) encoding second data into the synthetically generated media file using the steganography encoder to generate an encoded media file, the second data being based at least in part on the first data; (3) processing the encoded media file using the steganography decoder to generate decoded data; (4) generating an accuracy loss value based at least in part on the second data and the decoded data; and (5) modifying one or both of: one or more parameters of the steganography encoder, based at least in part on the accuracy loss value; or one or more parameters of the steganography decoder, based at least in part on the accuracy loss value. In some aspects, the memory further stores a discriminative model, and the one or more processors are further configured to: generate a discriminative loss value based at least in part on processing the encoded media file using the discriminative model; and modify one or more parameters of the steganography encoder based at least in part on the discriminative loss value. In some aspects, the steganography encoder is a part of the generative model. In some aspects, encoding the second data into the synthetically generated media file using the steganography encoder to generate the encoded media file comprises encoding a text sequence into the encoded media file. In some aspects, encoding the second data into the synthetically generated media file using the steganography encoder to generate the encoded media file comprises encoding a tokenized version of a text sequence into the encoded media file. In some aspects, encoding the second data into the synthetically generated media file using the steganography encoder to generate the encoded media file comprises encoding a vector embedding based on a text sequence into the encoded media file.

In another aspect, the disclosure describes a processing system comprising: (A) a memory storing a generative model, a steganography encoder, and a discriminative model; and (B) one or more processors coupled to the memory and configured to train the steganography encoder, comprising: generating a synthetically generated media file based at least in part on first data using the generative model; encoding second data into the synthetically generated media file using the steganography encoder to generate an encoded media file, the second data being based at least in part on the first data; generating a discriminative loss value based at least in part on processing the encoded media file using the discriminative model; and modifying one or more parameters of the steganography encoder based at least in part on the discriminative loss value. In some aspects, encoding the second data into the synthetically generated media file using the steganography encoder to generate the encoded media file comprises encoding a text sequence into the encoded media file. In some aspects, encoding the second data into the synthetically generated media file using the steganography encoder to generate the encoded media file comprises encoding a tokenized version of a text sequence into the encoded media file. In some aspects, encoding the second data into the synthetically generated media file using the steganography encoder to generate the encoded media file comprises encoding a vector embedding based on a text sequence into the encoded media file.

In another aspect, the disclosure describes a processing system comprising: (A) a memory storing a steganography encoder and a steganography decoder; and (B) one or more processors coupled to the memory and configured to train one or both of the steganography encoder or the steganography encoder, comprising: (1) encoding first data into a media file using the steganography encoder to generate an encoded media file; (2) processing the encoded media file using the steganography decoder to generate decoded data; (3) generating an accuracy loss value based at least in part on the first data and the decoded data; and (4) modifying one or both of: one or more parameters of the steganography encoder, based at least in part on the accuracy loss value; or one or more parameters of the steganography decoder, based at least in part on the accuracy loss value. In some aspects, the memory further stores a discriminative model, and the one or more processors are further configured to: generate a discriminative loss value based at least in part on processing the encoded media file using the discriminative model; and modify one or more parameters of the steganography encoder based at least in part on the discriminative loss value. In some aspects, the steganography encoder is a part of a generative model. In some aspects, encoding the first data into the media file using the steganography encoder to generate the encoded media file comprises encoding a text sequence into the encoded media file. In some aspects, encoding the first data into the media file using the steganography encoder to generate the encoded media file comprises encoding a tokenized version of a text sequence into the encoded media file. In some aspects, encoding the first data into the media file using the steganography encoder to generate the encoded media file comprises encoding a vector embedding based on a text sequence into the encoded media file.

In another aspect, the disclosure describes a processing system comprising: (A) a memory storing a generative model and an interpretive model; and (B) one or more processors coupled to the memory and configured to train the generative model, comprising: generating a synthetically generated media file based at least in part on first data using the generative model; processing the synthetically generated media file using the interpretive model to generate first interpreted data; generating a first accuracy loss value based at least in part on the first data and the first interpreted data; and modifying one or more parameters of the generative model based at least in part on the first accuracy loss value. In some aspects, the memory further stores a steganography encoder, and the one or more processors are further configured to: identify a difference between the first data and the first interpreted data; encode second data into the synthetically generated media file using the steganography encoder to generate an encoded media file, the second data being based at least in part on the identified difference; process the encoded media file using the interpretive model to generate second interpreted data; generate a second accuracy loss value based at least in part on the first data and the second interpreted data; and modify one or more parameters of the steganography encoder based at least in part on the first accuracy loss value and the second accuracy loss value. In some aspects, the one or more processors are further configured to: modify one or more parameters of the generative model based at least in part on the first accuracy loss value and the second accuracy loss value. In some aspects, the steganography encoder is a part of the generative model. In some aspects, encoding the second data into the synthetically generated media file using the steganography encoder to generate the encoded media file comprises encoding one or more words or characters into the encoded media file. In some aspects, encoding the second data into the synthetically generated media file using the steganography encoder to generate the encoded media file comprises encoding a tokenized version of one or more words or characters into the encoded media file. In some aspects, encoding the second data into the synthetically generated media file using the steganography encoder to generate the encoded media file comprises encoding a vector embedding based on one or more words into the encoded media file.

In another aspect, the disclosure describes a processing system comprising: (A) a memory storing a steganography decoder; and (B) one or more processors coupled to the memory and configured to: process an encoded media file using the steganography decoder to generate decoded data; output media content of the encoded media file; determine, based on the decoded data, whether the media content of the encoded media file was generated by a generative model; and based on the determination, output an indication of whether the encoded media file was generated by a generative model. In some aspects, the one or more processors are further configured to output the indication of whether the encoded media file was generated by a generative model in response to receiving an input from a user. In some aspects, the one or more processors are further configured to output the decoded data. In some aspects, the one or more processors are further configured to output the decoded data in response to receiving an input from a user.

In another aspect, the disclosure describes a processing system comprising: (A) a memory storing a generative model and a steganography encoder; and (B) one or more processors coupled to the memory and configured to: generate a synthetically generated media file based at least in part on first data using a generative model; and encode second data into the synthetically generated media file using a steganography encoder to generate an encoded media file, the second data being based at least in part on the first data. In some aspects, the steganography encoder is a part of the generative model. In some aspects, encoding the second data into the synthetically generated media file using the steganography encoder to generate the encoded media file comprises encoding one or more words of the first data into the encoded media file. In some aspects, encoding the second data into the synthetically generated media file using the steganography encoder to generate the encoded media file comprises encoding a tokenized version of one or more words of the first data into the encoded media file. In some aspects, encoding the second data into the synthetically generated media file using the steganography encoder to generate the encoded media file comprises encoding a vector embedding based on one or more words of the first data into the encoded media file. In some aspects, encoding the second data into the synthetically generated media file using the steganography encoder to generate the encoded media file comprises encoding a vector into the encoded media file, the vector representing a classification generated by an interpretive model based on the first data.

### BRIEF DESCRIPTION OF THE DRAWINGS

FIG. 1 is a functional diagram of an example system in accordance with aspects of the disclosure.

FIG. 2 is a functional diagram of an example system in accordance with aspects of the disclosure.

FIG. 3 shows an exemplary process flow illustrating how a generative model and a steganography encoder may be used to generate an encoded media file, in accordance with aspects of the disclosure.

FIG. 4 shows an exemplary process flow illustrating how a model including a generative model and a steganography encoder may be used to generate an encoded media file, in accordance with aspects of the disclosure.

FIG. 5 shows an exemplary process flow illustrating how metadata may be encoded into an existing media file using a steganography encoder to generate an encoded media file, in accordance with aspects of the disclosure.

FIGS. 6A-6C show exemplary process flows illustrating how an accuracy loss can be generated based on the process flows of FIGS. 3-5, in accordance with aspects of the disclosure.

FIG. 7 shows an exemplary process flow illustrating how an accuracy loss can be generated where the generative model does not use steganography, in accordance with aspects of the disclosure.

FIGS. 8A-8C show exemplary process flows illustrating how an accuracy loss can be generated based on the process flows of FIGS. 6A-6C, in accordance with aspects of the disclosure.

FIG. 9 sets forth an exemplary method for generating a synthetically generated media file and encoding it using steganography, in accordance with aspects of the disclosure.

FIG. 10 sets forth an exemplary method that expands on the exemplary method of FIG. 9 to generate an accuracy loss value and train a steganography encoder and/or steganography decoder based on the accuracy loss value, in accordance with aspects of the disclosure.

FIG. 11 sets forth an exemplary method that may be performed after the exemplary methods of FIG. 9 or FIG. 10 to generate a discriminative loss value and train a steganography encoder based on the discriminative loss value, in accordance with aspects of the disclosure.

FIG. 12 sets forth an exemplary method for encoding a preexisting media file using steganography, generating an accuracy loss value, and training a steganography encoder and/or steganography decoder based on the accuracy loss value, in accordance with aspects of the disclosure.

FIG. 13 sets forth an exemplary method that may be performed after selected steps of FIG. 12 to generate a discriminative loss value and train a steganography encoder based on the discriminative loss value, in accordance with aspects of the disclosure.

FIG. 14 sets forth an exemplary method for generating a synthetically generated media file, generating a first accuracy loss value, and training a generative model based on the first accuracy loss value, in accordance with aspects of the disclosure.

FIG. 15 sets forth an exemplary method that may be performed after selected steps of FIG. 14 to identify second data to be encoded into the synthetically generated media file, generate a second accuracy loss value, and train the generative model and/or the steganography encoder based on the first and second accuracy loss values, in accordance with aspects of the disclosure.

FIG. 16 sets forth an exemplary method for processing an encoded media file and outputting its associated media and an indication of how it was generated, in accordance with aspects of the disclosure.

### DETAILED DESCRIPTION

The present technology will now be described with respect to the following exemplary systems and methods.

### Example Systems

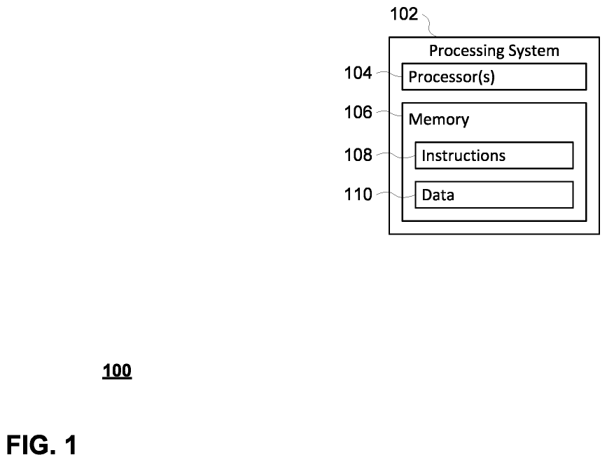

FIG. 1 shows a high-level system diagram 100 of an exemplary processing system 102 for performing the methods described herein. The processing system 102 may include one or more processors 104 and memory 106 storing instructions 108 and data 110. The instructions 108 and data 110 may include any of the models and/or utilities described herein, such as models for generating synthetic media (e.g., TTS models for generating synthesized speech, music generation models for generating songs, image generation models for generating images, video generation models for generating videos, sound enhancement models for modifying audio files, image enhancement models for modifying image files, video enhancement models for modifying video files, text rendering models for generating images including rendered text, handwriting rendering models for generating images including synthesized handwriting, virtual avatar generation models for generating virtual avatars, etc.), models for embedding information into synthetic or human-generated media (e.g., steganography encoders), models for processing the media (e.g., ASR models), and/or models for identifying and decoding information embedded in the media (e.g., steganography decoders). In addition, the data 110 may store training examples to be used in training such models, data to be used by such models when generating media or embedding metadata, and/or the outputs of any such models.

Processing system 102 may be resident on a single computing device. For example, processing system 102 may be a server, personal computer, or mobile device, and a given model may thus be local to that single computing device. Similarly, processing system 102 may be resident on a cloud computing system or other distributed system. In such a case, a given model may be distributed across two or more different physical computing devices. For example, in some aspects of the technology, the processing system may comprise a first computing device storing layers 1-n of a given model having m layers, and a second computing device storing layers n-m of the given model.

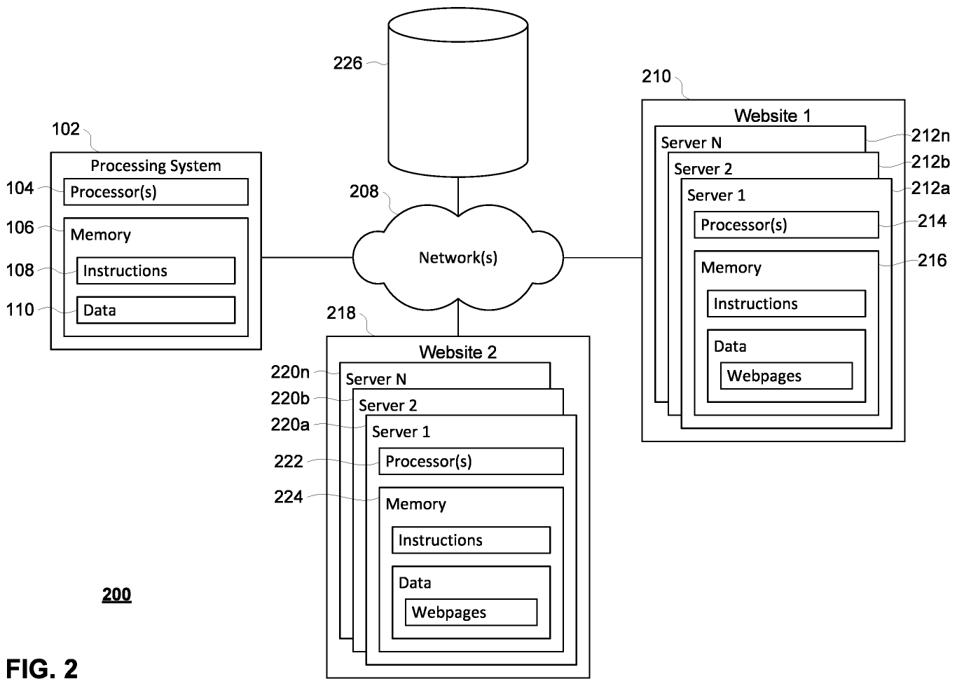

Further in this regard, FIG. 2 shows a high-level system diagram 200 in which the exemplary processing system 102 just described is shown in communication with various websites and/or remote storage systems over one or more networks 208, including websites 210 and 218 and remote storage system 226. In this example, websites 210 and 218 each include one or more servers 212a-212n and 220a-220n, respectively. Each of the servers 212a-212n and 220a-220n may have one or more processors (e.g., 214 and 222), and associated memory (e.g., 216 and 224) storing instructions and data, including the content of one or more webpages. Likewise, although not shown, remote storage system 226 may also include one or more processors and memory storing instructions and data. In some aspects of the technology, the processing system 102 may be configured to retrieve data and/or training examples from one or more of website 210, website 218, and/or remote storage system 226 to be provided to a given model for training or to be used when generating media or embedding metadata.

The processing systems described herein may be implemented on any type of computing device(s), such as any type of general computing device, server, or set thereof, and may further include other components typically present in general purpose computing devices or servers. Likewise, the memory of such processing systems may be of any non-transitory type capable of storing information accessible by the processor(s) of the processing systems. For instance, the memory may include a non-transitory medium such as a hard-drive, memory card, optical disk, solid-state, tape memory, or the like. Computing devices suitable for the roles described herein may include different combinations of the foregoing, whereby different portions of the instructions and data are stored on different types of media.

In all cases, the computing devices described herein may further include any other components normally used in connection with a computing device such as a user interface subsystem. The user interface subsystem may include one or more user inputs (e.g., a mouse, keyboard, touch screen and/or microphone) and one or more electronic displays (e.g., a monitor having a screen or any other electrical device that is operable to display information). Output devices besides an electronic display, such as speakers, lights, and vibrating, pulsing, or haptic elements, may also be included in the computing devices described herein.

The one or more processors included in each computing device may be any conventional processors, such as commercially available central processing units (“CPUs”), graphics processing units (“GPUs”), tensor processing units (“TPUs”), etc. Alternatively, the one or more processors may be a dedicated device such as an ASIC or other hardware-based processor. Each processor may have multiple cores that are able to operate in parallel. The processor(s), memory, and other elements of a single computing device may be stored within a single physical housing, or may be distributed between two or more housings. Similarly, the memory of a computing device may include a hard drive or other storage media located in a housing different from that of the processor(s), such as in an external database or networked storage device. Accordingly, references to a processor or computing device will be understood to include references to a collection of processors or computing devices or memories that may or may not operate in parallel, as well as one or more servers of a load-balanced server farm or cloud-based system.

The computing devices described herein may store instructions capable of being executed directly (such as machine code) or indirectly (such as scripts) by the processor(s). The computing devices may also store data, which may be retrieved, stored, or modified by one or more processors in accordance with the instructions. Instructions may be stored as computing device code on a computing device-readable medium. In that regard, the terms “instructions” and “programs” may be used interchangeably herein. Instructions may also be stored in object code format for direct processing by the processor(s), or in any other computing device language including scripts or collections of independent source code modules that are interpreted on demand or compiled in advance. By way of example, the programming language may be C#, C++, JAVA or another computer programming language. Similarly, any components of the instructions or programs may be implemented in a computer scripting language, such as JavaScript, PHP, ASP, or any other computer scripting language. Furthermore, any one of these components may be implemented using a combination of computer programming languages and computer scripting languages.

### Example Methods

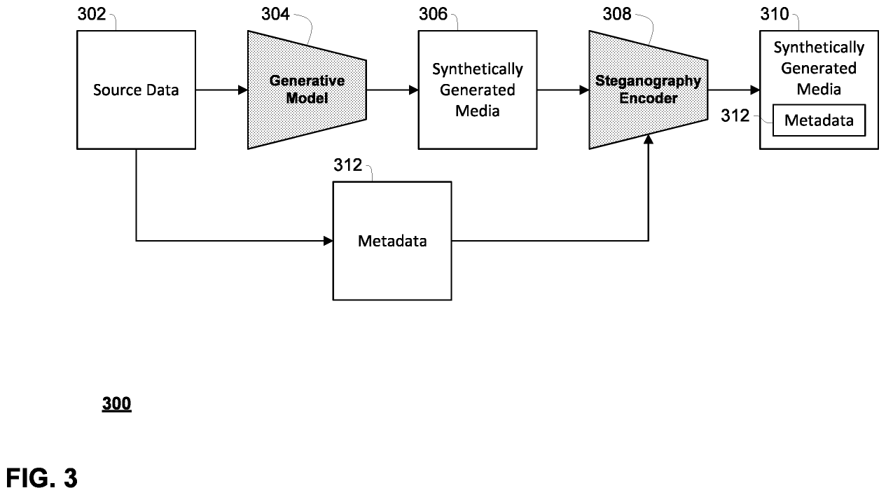

FIG. 3 shows an exemplary process flow 300 illustrating how a generative model 304 and a steganography encoder 308 may be used to generate an encoded media file 310, in accordance with aspects of the disclosure. In that regard, in the example of FIG. 3, source data 302 is used by a generative model 304 to generate a synthetically generated media file 306. A steganography encoder 308 then encodes metadata 312 into the synthetically generated media file 306 to generate encoded media file 310, the metadata 312 being based at least in part on the source data 302. Process flow 300 may thus be used to generate an encoded media file 310 that is a version of the synthetically generated media file 306, but which has been modified using steganography to include metadata 312.

In the example of FIG. 3, generative model 304 may be any suitable type of generative model, such as a TTS model for generating synthesized speech, a music generation model for generating an audio file, an image generation model for generating an image file, a video generation model for generating a video file, a sound enhancement model for modifying an audio file, an image enhancement model for modifying an image file, a video enhancement model for modifying a video file, a text rendering model for generating an image including rendered text, a handwriting rendering model for generating an image including synthesized handwriting, a virtual avatar generation model for generating a virtual avatar, etc. For example, in some aspects of the technology, source data 302 may be a text sequence, generative model 304 may be a TTS model, and the synthetically generated media file 306 may be an audio file including synthesized speech generated by the TTS model based on the text sequence.

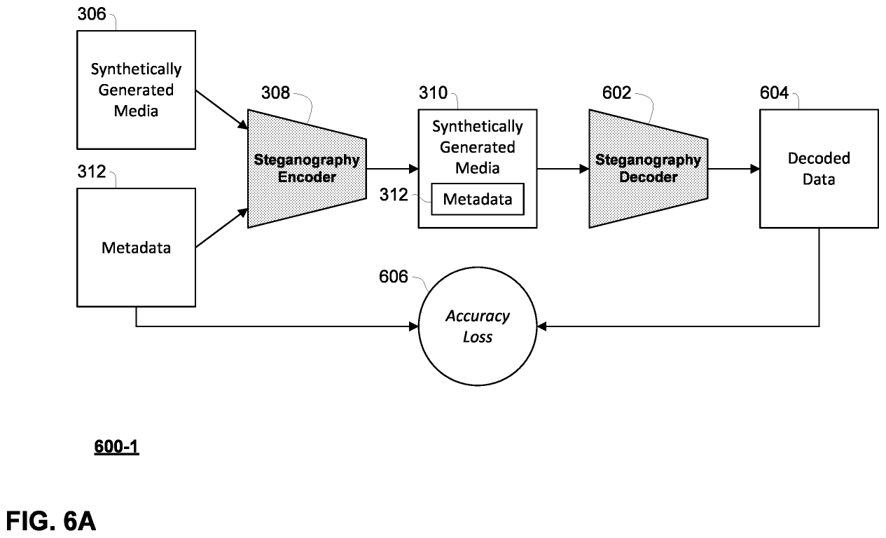

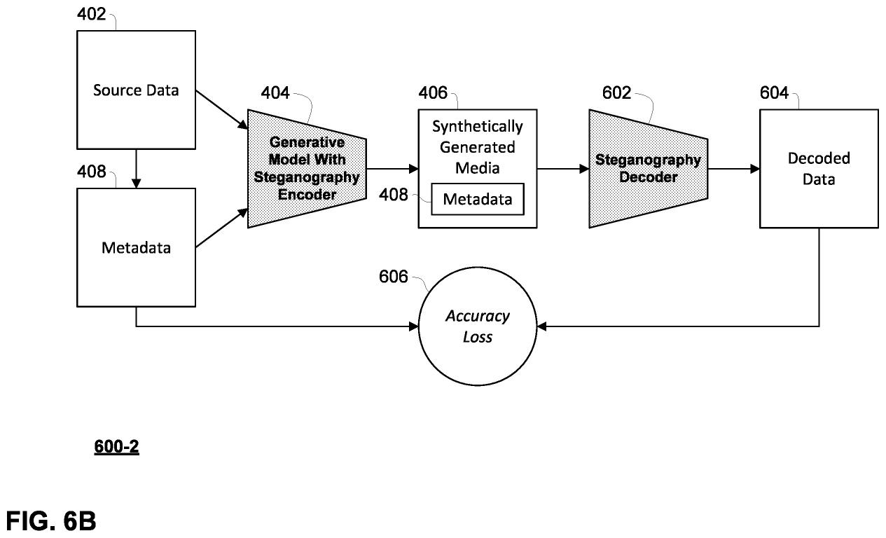

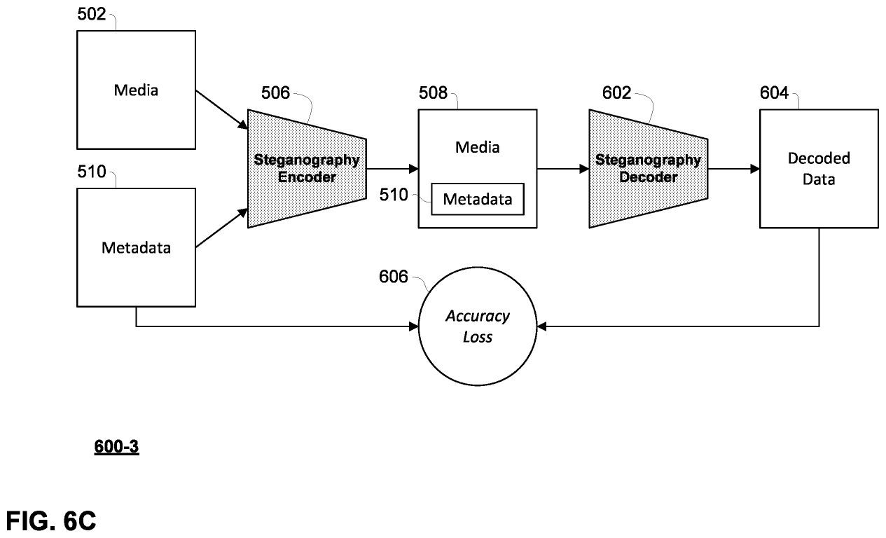

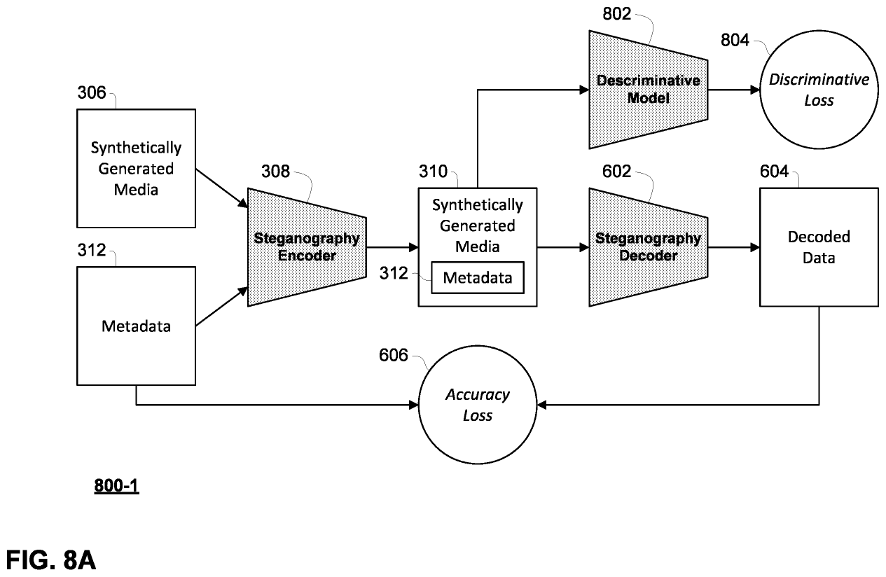

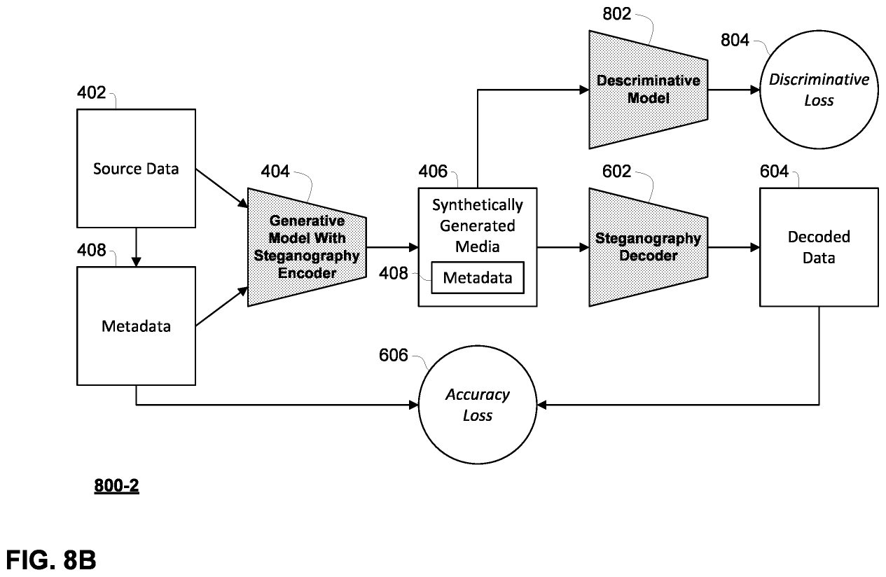

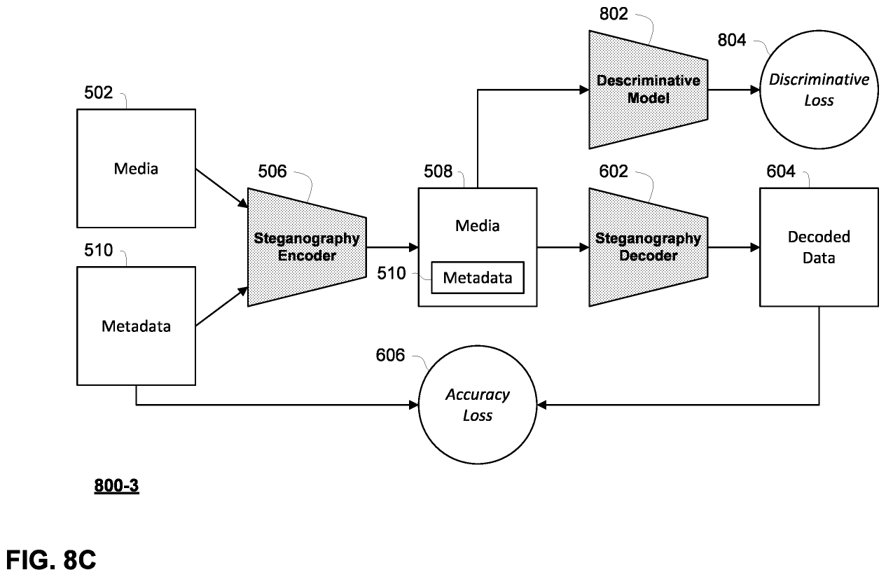

Likewise, in the example of FIG. 3, steganography encoder 308 may be any suitable type of encoder configured to encode metadata 312 into a particular type of media file (e.g., audio, image, video, rendered text, etc.) to generate an encoded media file 310. In that regard, steganography encoder 308 may be an existing heuristic-based watermarking or steganography utility, or may be a learned encoder. Further, in some aspects of the technology, where steganography encoder 308 is a learned encoder, it may be trained (e.g., parameterized) to generate encoded media files 310 in which the metadata 312 is more likely to be accurately decoded by a particular steganography decoder (e.g., as discussed below with respect to FIGS. 6B, 6C, 8B, 8C, 10, and 12) and/or to encode metadata 312 into the encoded media files 310 in ways that are less likely to be perceived by a human (e.g., as discussed below with respect to FIGS. 8B, 8C, 11, and 13).

Further, in the example of FIG. 3, metadata 312 may be based on source data 302 in any suitable way. In that regard, metadata 312 may be identical to source data 302, may include all or some of source data 302, and/or may include information based on source data 302. Thus, using the example discussed above in which source data 302 is a text sequence, generative model 304 is a TTS model, and the synthetically generated media file 306 is an audio file including synthesized speech generated by the TTS model based on the text sequence, the metadata 312 may be a copy of all or a portion of the text sequence (e.g., metadata 312 may be the full text sequence, or simply a hint comprising one or more words of the text sequence), a tokenized version of all or a portion of the text sequence, a vector embedding based on all or a portion of the text sequence, a vector based on all or a portion of the text sequence that is configured to amplify a given classification when the encoded media file 310 is interpreted by a given model, an identified difference between the text sequence and another text sequence output by a given interpretive model based on the encoded media file 310 (e.g., as discussed below with respect to FIG. 15), a vector based on such an identified difference (e.g., as also discussed below with respect to FIG. 15), etc. Likewise, in some aspects of the technology, where source data 302 includes an original text sequence in a first language, metadata 312 may include a copy of a full or partial translation of the text sequence into a sequence language, a tokenized version of such full or partial translation, a vector embedding based on such full or partial translation, etc.

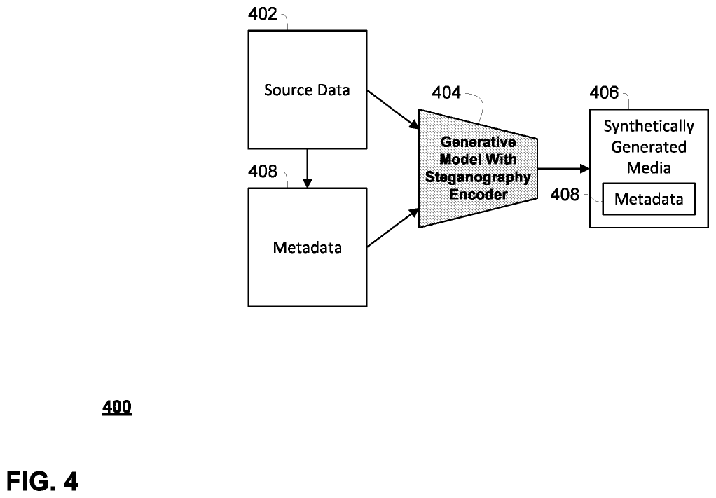

Although the examples of FIG. 3 depicts the generative model 304 and the steganography encoder 308 as separate elements, in some aspects of the technology, they may be parts of a single model. FIG. 4 shows an exemplary process flow 400 illustrating how a model 404 including a generative model and a steganography encoder may be used to generate an encoded media file 406, in accordance with aspects of the disclosure.

The only difference between the examples of FIGS. 3 and 4 is that the generative model and the steganography encoder are combined into a single model 404 in FIG. 4. Thus, source data 402 may be the same as the source data 302 described above, and may be used by the model 404 to generate an encoded media file 406 as described above. As with encoded media file 310, the encoded media file 406 will include synthetically generated media which has been generated by the model 404 based on the source data 402, and will further include metadata 408 based at least in part on source data 402 which has been encoded into the synthetically generated media by the steganography encoder of model 404. In some aspects of the technology, the model 404 may be configured to generate the synthetically generated media of encoded media file 406 first, and then to encode metadata 408 into the synthetically generated media in a subsequent process. Likewise, in some aspects of the technology, the model 404 may be configured to generate and encode the media simultaneously.

In the example of FIG. 4, the generative model within model 404 may be any suitable type of generative model, including all options discussed above with respect to generative model 304 of FIG. 3. Likewise, the steganography encoder incorporated into model 404 may be any suitable type of encoder configured to encode metadata 408 into a particular type of media file (e.g., audio, image, video, rendered text, etc.) to generate an encoded media file 406, including all options discussed above with respect to steganography encoder 308 of FIG. 3. Further, metadata 408 may be based on source data 402 in any suitable way, including the ways discussed above in which metadata 312 may be based on the source data 302 of FIG. 3.

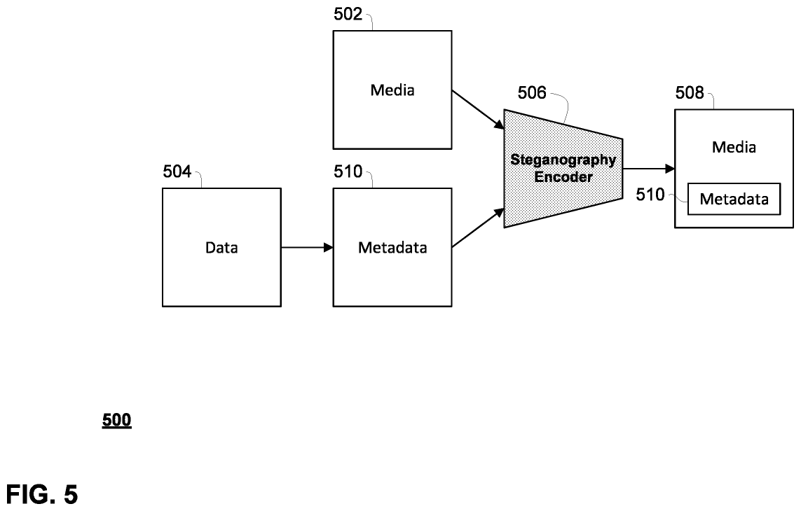

Although the example of FIGS. 3 and 4 assume that media will be synthetically generated by a given generative model, in some aspects of the technology, a steganography encoder may also be used to encode metadata into a pre-existing media file. FIG. 5 shows an exemplary process flow 500 illustrating how metadata 510 may be encoded into an existing media file 502 using a steganography encoder 506 to generate an encoded media file 508, in accordance with aspects of the disclosure. As above, in the example of FIG. 5, the metadata 510 which is encoded into the encoded media file 508 is based at least in part on the data 504. Process flow 500 may thus also be used to generate an encoded media file 508 that is a version of the preexisting media file 502, but which has been modified using steganography to include metadata 510.

In the example of FIG. 5, media file 502 may be an existing media file that was generated in any suitable way. For example, media file 502 may have been previously generated by a generative model not shown in FIG. 5. Likewise, media file 502 may be one that was generated in whole or in part by one or more human creators, such as an audio file that includes a recording of one or more human musicians or voice actors, an image file that includes a photograph taken by a human photographer, an image file that includes a piece of visual art created by a human artist, a video file including a recording of one or more human actors, a video file including an animation created by one or more human animators, etc. Further, in some aspects of the technology, the media file 502 may be one that includes content generated by a human creator, which was then further modified or supplemented by a machine (e.g., a recording of a human musician that was mixed with a portion of music generated by a music generation model, an image including a photograph taken by a human that was enhanced with an image enhancement model, etc.).

Likewise, in the example of FIG. 5, data 504 may include any information related to media file 502. In that regard, data 504 may include any metadata fields belonging to media file 502 (e.g., filename, file size, created date and/or time, author, last modified date and/or time, editor, etc.), and/or any other information relevant to the media file (e.g., close-captioning data or a transcript of dialogue in the media file, location data for an image file, etc.). Likewise, where media file 502 includes synthetically generated content, data 504 may include any of the information described above with respect to source data 302 and 402 of FIGS. 3 and 4.

Further, in the example of FIG. 5, the steganography encoder 506 may be any suitable type of encoder configured to encode metadata 510 into a particular type of media file (e.g., audio, image, video, rendered text, etc.) in order to generate an encoded media file 508, including all options discussed above with respect to steganography encoder 308 of FIG. 3. In addition, metadata 510 may be based on data 504 in any suitable way, including the ways discussed above in which metadata 312 may be based on the source data 302 of FIG. 3.

FIGS. 6A-6C show exemplary process flows 600-1, 600-2, and 600-3 illustrating how an accuracy loss can be generated based on the process flows of FIGS. 3-5, in accordance with aspects of the disclosure. More specifically, the exemplary process flow 600-1 of FIG. 6A shows how the process flow 300 of FIG. 3 may be supplemented to generate an accuracy loss 606, the exemplary process flow 600-2 of FIG. 6B shows how the process flow 400 of FIG. 4 may be supplemented to generate an accuracy loss 606, and the exemplary process flow 600-3 of FIG. 6C shows how the process flow 500 of FIG. 5 may be supplemented to generate an accuracy loss 606. As such, each of the numbered elements of FIG. 6A that are in common with FIG. 3 are as described above, each of the numbered elements of FIG. 6B that are in common with FIG. 4 are as described above, and each of the elements of FIG. 6C that are in common with FIG. 5 are as described above.

In each of the examples of FIGS. 6A-6C, after the encoded media file (310, 406, or 508) is generated, the encoded media file is processed by a steganography decoder 602 to generate decoded data 604. The processing system (e.g., processing system 102) may then generate an accuracy loss value 606 based the decoded data 604 and the metadata (312, 408, or 510).

The steganography decoder 602 of FIGS. 6A-6C may be may be any suitable type of decoder configured to identify the presence of encoded metadata (312, 408, or 510) in a particular type of media file (e.g., audio, image, video, etc.), and to decode it into decoded data 604. Thus, in some aspects of the technology, steganography decoder 602 may simply be an inverted version of whatever heuristic-based or learned steganography encoder (308, 404, or 506) was used to generate the encoded media file (310, 406, or 508). Likewise, steganography decoder 602 may be any other suitable learned or heuristic-based decoder for decoding watermarks or steganographic data.

In the examples of FIGS. 6A-6C, the processing system may generate accuracy loss value 606 in any suitable way using any suitable loss function. For example, in some aspects of the technology, where metadata (312, 408, or 510) and decoded data 604 are in text format, the processing system may be configured to perform a comparison of the text of the metadata (312, 408, or 510) and the decoded data 604 to determine if any words, letters, numbers, or other characters differ. If so, in some aspects of the technology, the processing system may be configured to quantify the difference (e.g., by assigning a score based on how many characters or words were decoded correctly divided by the total number of characters or words in the metadata (312, 408, or 510)). Likewise, in some aspects of the technology, the processing system may be configured to simply assign one value if the decoded data 604 exactly matches the metadata (312, 408, or 510) (e.g., 1), and another value if the decoded data 604 differs from the metadata (312, 408, or 510) in any way (e.g., 0). Although these options are provided for illustrative purposes, it will be understood that the accuracy loss value 606 may be based on any suitable way of comparing metadata (312, 408, or 510) and decoded data 604 to determine whether and/or how accurately the steganography decoder 602 was able to decode the metadata (312, 408, or 510) from within the encoded media file (310, 406, or 508).

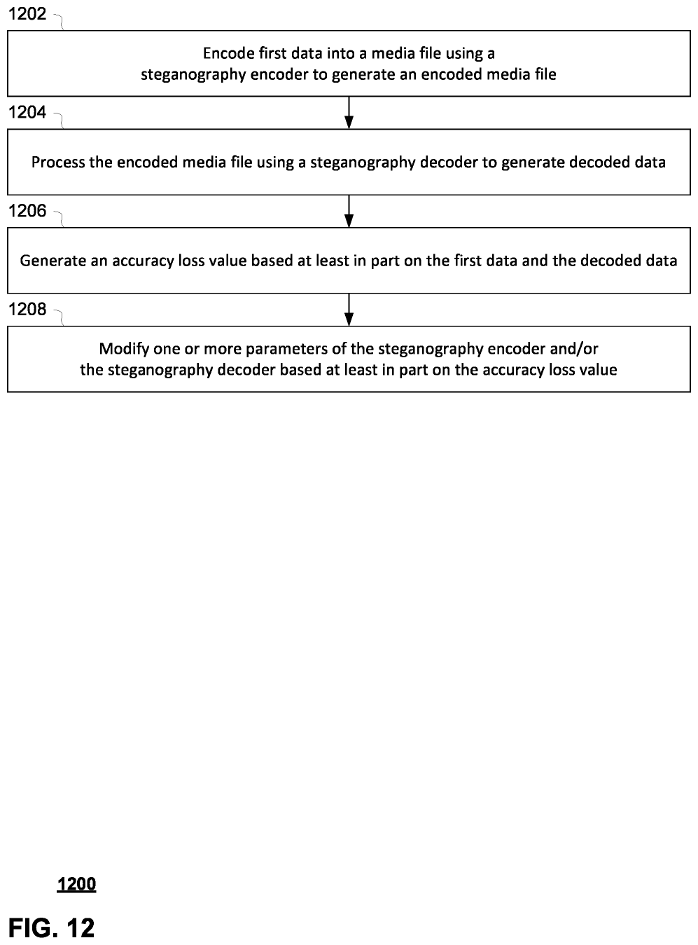

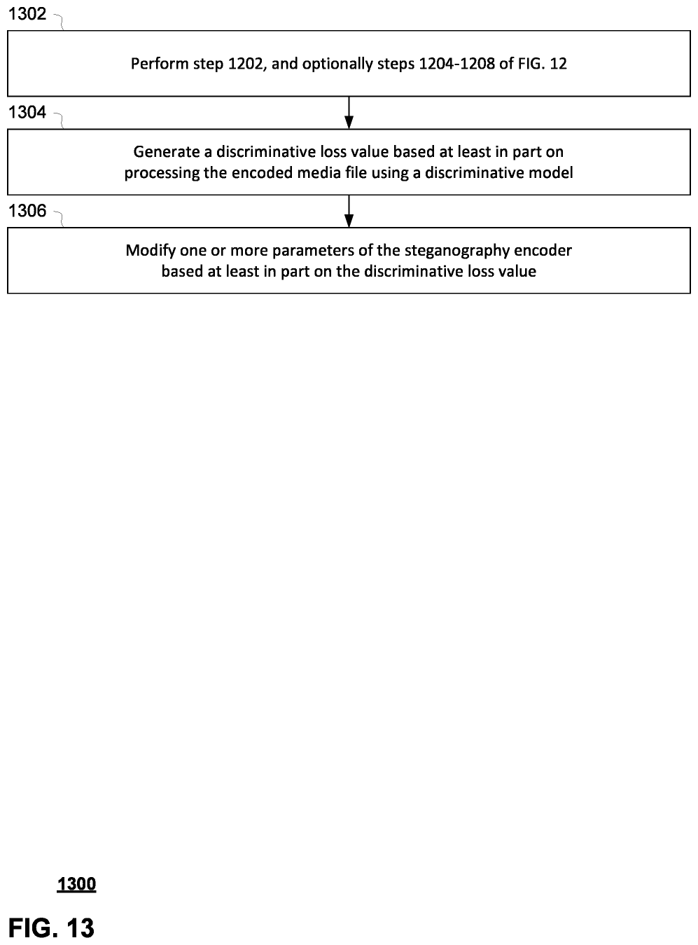

As described further below with respect to FIGS. 10 and 12, the accuracy loss value 606 generated in the exemplary process flows 600-1, 600-2, and 600-3 may be used (alone or as a part of an aggregated loss value) to modify one or more parameters of whatever utility (model 404, or dedicated steganography encoder 308 or 506) was used to encode the metadata (312, 408, or 510) into the encoded media file (310, 406, or 508), and/or to modify one or more parameters of steganography decoder 602. Through this process, the utility (model 404, or dedicated steganography encoder 308 or 506) may be tuned or trained (e.g., parameterized) to encode metadata into the encoded media file in a way that is more likely to be correctly decoded by the steganography decoder 602.

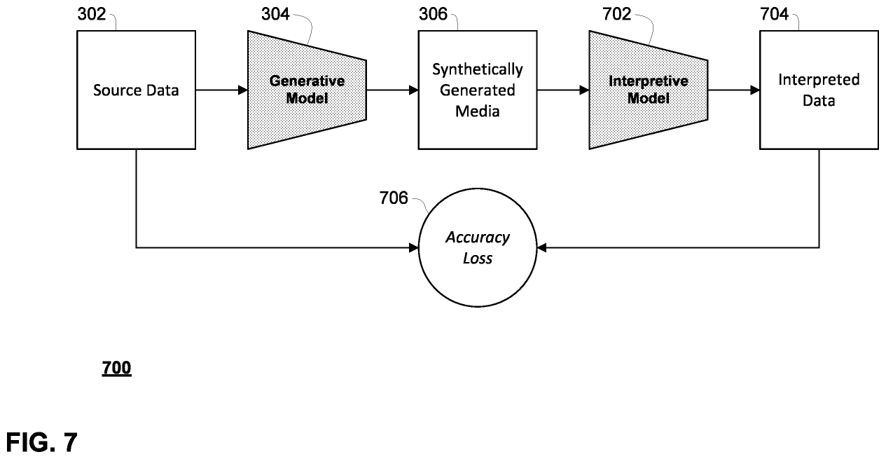

FIG. 7 shows an exemplary process flow 700 illustrating how an accuracy loss can be generated where the generative model does not use steganography, in accordance with aspects of the disclosure. In that regard, the exemplary process flow 700 shows how the first three elements of the process flow 300 of FIG. 3 may be supplemented to generate an accuracy loss 706. Here as well, each of the numbered elements of FIG. 7 that are in common with FIG. 3 are as described above.

In the example of FIG. 7, after the synthetically generated media file 306 is generated, the synthetically generated media file 306 is processed by an interpretive model 702 to generate interpreted data 704. The processing system (e.g., processing system 102) may then generate an accuracy loss value 706 based on the source data 302 and the interpreted data 704.

The interpretive model 702 of FIG. 7 may be any suitable type of model configured to interpret the content of a particular type of media file (e.g., audio, image, video, rendered text, etc.) to generate interpreted data 704. Thus, using the example discussed above in which source data 302 is a text sequence, generative model 304 is a TTS model, and the synthetically generated media file 306 is an audio file including synthesized speech generated by the TTS model based on the text sequence, the interpretive model 702 may be an ASR model configured to process the audio file to generate another text sequence representing the ASR model's interpretation of the words being spoken in the audio file. In such a case, the interpreted data 704 may be the text sequence output by the interpretive model 702. Likewise, the exemplary process flow 700 may be employed with any other suitable type of interpretive model 702, such as models configured to identify objects or text in images or video, models configured to identify speech from silent video or images, etc.

As with the examples of FIGS. 6A-6C, the processing system may generate accuracy loss value 706 in any suitable way using any suitable loss function. For example, in some aspects of the technology, where source data 302 (or a portion thereof) and interpreted data 704 are in text format, the processing system may be configured to perform a comparison of the text of the source data 302 and the interpreted data 704 to determine if any words, letters, numbers, or other characters differ. If so, in some aspects of the technology, the processing system may be configured to quantify the difference (e.g., by assigning a score based on how many characters or words were interpreted correctly divided by the total number of characters or words in the source data 302). Likewise, in some aspects of the technology, the processing system may be configured to simply assign one value if the interpreted data 704 exactly matches the source data 302 (e.g., 1), and another value if the interpreted data 704 differs from the source data 302 in any way (e.g., 0). Here as well, although these options are provided for illustrative purposes, it will be understood that the accuracy loss value 706 may be based on any suitable way of comparing source data 302 and interpreted data 704 to determine whether and/or how accurately the interpretive model 702 was able to interpret the synthetically generated media file 306.

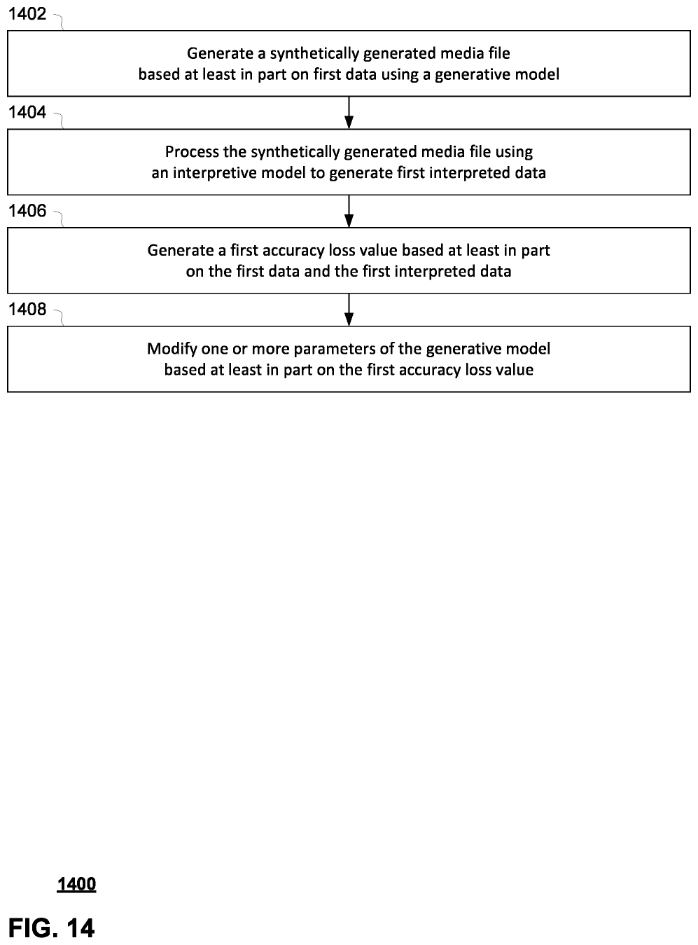

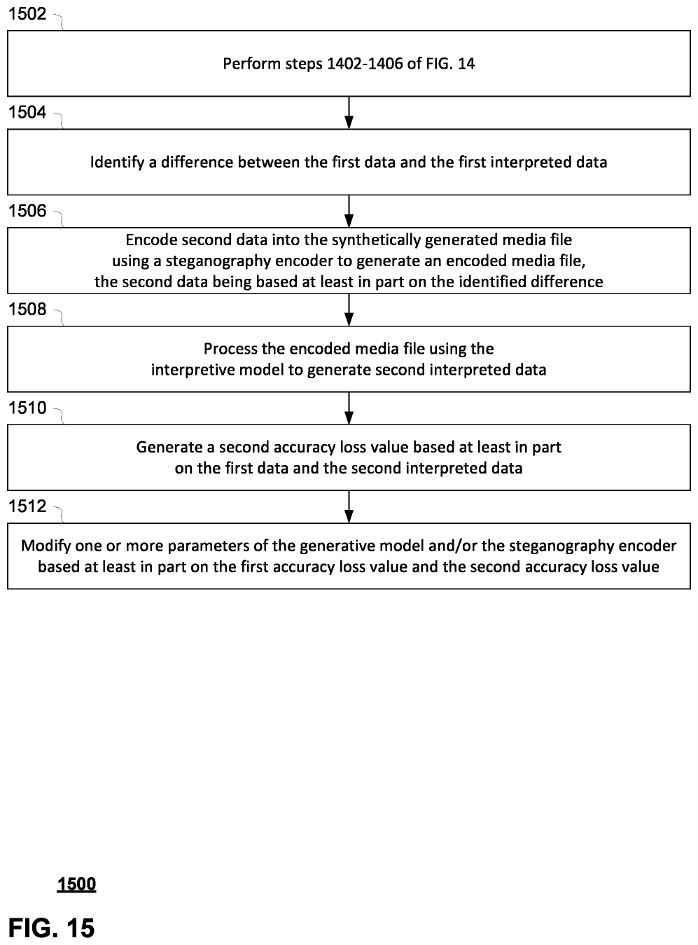

As described further below with respect to FIG. 14, the accuracy loss value 706 generated in the exemplary process flow 700 may be used (alone or as a part of an aggregated loss value) to modify one or more parameters of the generative model 304 which was used to generate the synthetically generated media file 306. Through this process, the generative model 304 may be tuned or trained (e.g., parameterized) to generate synthetically generated media files that are more likely to be correctly interpreted by a given interpretive model 702. Thus, for example, where the generative model 304 is a TTS model configured to generate an audio file of synthesized speech and the interpretive model 702 is an ASR model configured to interpret the synthesized speech, the accuracy loss value 706 may be used to train (e.g., parameterize) the TTS model to generate synthetic speech that is more likely to be correctly understood by that ASR model. Likewise, in some aspects of the technology, a set of accuracy loss values 706 may be generated for a set of different interpretive models 702, and then used together (e.g., as part of an aggregated loss value) to train (e.g., parameterize) the generative model 304 to generate synthetically generated media files that are more likely to be correctly interpreted by that set of different interpretive models.

Likewise, as described further below with respect to FIG. 15, the accuracy loss value 706 generated in the exemplary process flow 700 may also be used to identify one or more hints to be encoded into the synthetically generated media file 306 using steganography so that a given interpretive model 702 will be more likely to correctly interpret the resulting encoded media file. Thus, for example, where the generative model 304 is a TTS model configured to generate an audio file of synthesized speech and the interpretive model 702 is an ASR model configured to interpret the synthesized speech, the accuracy loss value 706 may be used to identify one or more words, or a vector identifying a particular classification, that may be encoded into the audio file using steganography so that the ASR model will be more likely to correctly interpret the synthesized speech in the audio file.

FIGS. 8A-8C show exemplary process flows 800-1, 800-2, and 800-3 illustrating how an accuracy loss can be generated based on the process flows of FIGS. 6A-6C, in accordance with aspects of the disclosure. More specifically, the exemplary process flow 800-1 of FIG. 8A shows how the process flow 600-1 of FIG. 6A may be supplemented to generate a discriminative loss 804, the exemplary process flow 800-2 of FIG. 8B shows how the process flow 600-2 of FIG. 6B may be supplemented to generate a discriminative loss 804, and the exemplary process flow 800-3 of FIG. 8C shows how the process flow 600-3 of FIG. 6C may be supplemented to generate a discriminative loss 804. As such, each of the numbered elements of FIG. 8A that are in common with FIGS. 3 and 6A are as described above, each of the numbered elements of FIG. 8B that are in common with FIGS. 4 and 6B are as described above, and each of the elements of FIG. 8C that are in common with FIGS. 5 and 6C are as described above.

In each of the examples of FIGS. 8A-8C, after the encoded media file (310, 406, or 508) is generated, the encoded media file is provided to a discriminative model 802. The discriminative model 802 may be any suitable type of discriminative model configured to judge or classify whether the encoded media file (310, 406, or 508) sounds and/or appears realistic, such as would be found in a generative adversarial network. In that regard, discriminative model 802 may be a learned model trained to classify one or more different types of media files (e.g., audio, image, video, etc.). Likewise, discriminative model 802 may be any other suitable learned or heuristic-based utility for judging or classifying whether the encoded media file (310, 406, or 508) sounds and/or appears realistic.

In some aspects of the technology, the discriminative loss value 804 may be generated directly by the discriminative model based on the encoded media file (310, 406, or 508). Likewise, in some aspects of the technology, the discriminative model 802 may process the encoded media file (310, 406, or 508) to generate an output (e.g., a score or probability that the encoded media file is real, a classification of “real” or “fake,” etc.) based on which the processing system (e.g., processing system 102) then generates a discriminative loss value 804. In either case, the discriminative loss value 804 may be generated based on any suitable paradigm. For example, in some aspects of the technology, the discriminative loss value 804 may be based on how likely the encoded media file (310, 406, or 508) is to be real. Likewise, in some aspects of the technology, the discriminative loss value 804 may be one value if the encoded media file (310, 406, or 508) is predicted to be real (e.g., 1), and another value if the encoded media file (310, 406, or 508) is predicted to be fake (e.g., 0).

As described further below with respect to FIGS. 11 and 13, the discriminative loss value 804 generated in the exemplary process flows 800-1, 800-2, and 800-3 may be used (alone or as a part of an aggregated loss value) to modify one or more parameters of whatever utility (model 404, or dedicated steganography encoder 308 or 506) was used to encode the metadata (312, 408, 510) into the encoded media file (310, 406, or 508), and/or to modify one or more parameters of steganography decoder 602. In that regard, in some aspects of the technology, the accuracy loss value 606 and the discriminative loss value 804 may be combined in any suitable way (e.g., summed, averaged, summed in a weighted manner, etc.) to generate a combined loss value on which the one or more parameters of the utility are modified. Likewise, in some aspects, the accuracy loss value 606 and the discriminative loss value 804 may each be used to modify one or more parameters of the utility in separate processes. In either case, by using the discriminative loss value 804 to modify one or more parameters of the utility (model 404, or dedicated steganography encoder 308 or 506), the utility may be tuned or trained to encode metadata into the encoded media file in a way that is more likely to be imperceptible to a human and thus not degrade the quality of the media.

Although the exemplary process flows of FIGS. 8A-8C represent supplements to the process flows of FIGS. 6A-6C, a discriminative loss value 804 may also be calculated without calculating an accuracy loss value 606. In that regard, elements 602-606 of FIGS. 8A-8C may be considered optional, as described further below with respect to step 1102 of FIG. 11 and step 1302 of FIG. 13.

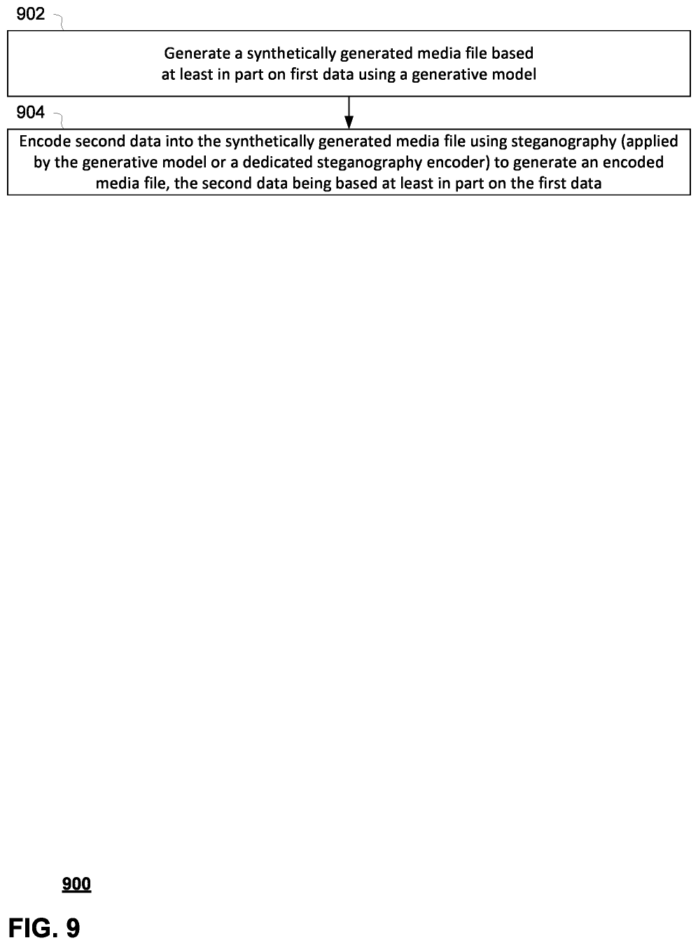

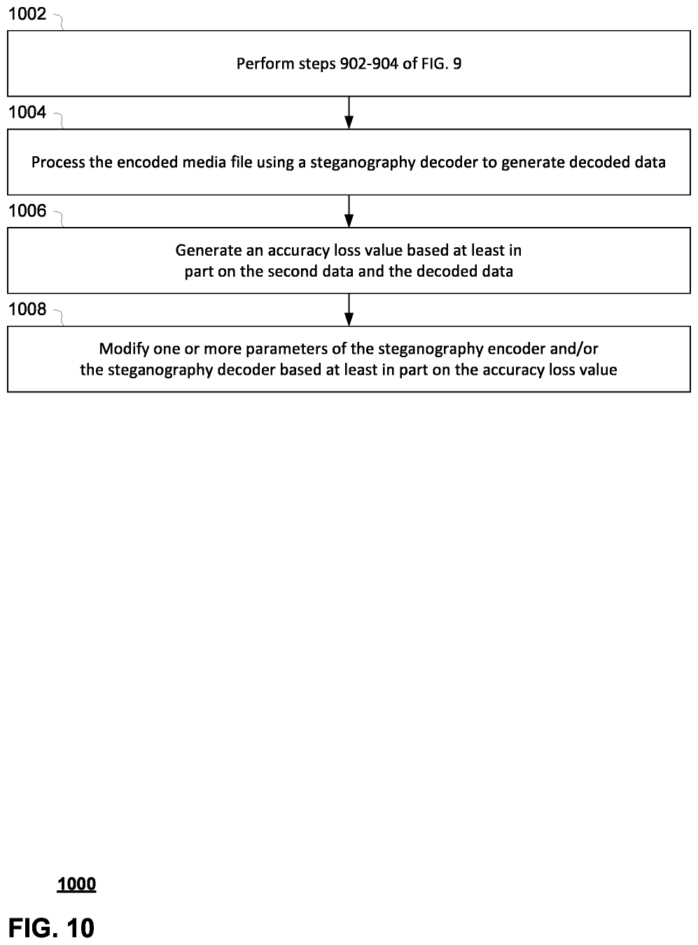

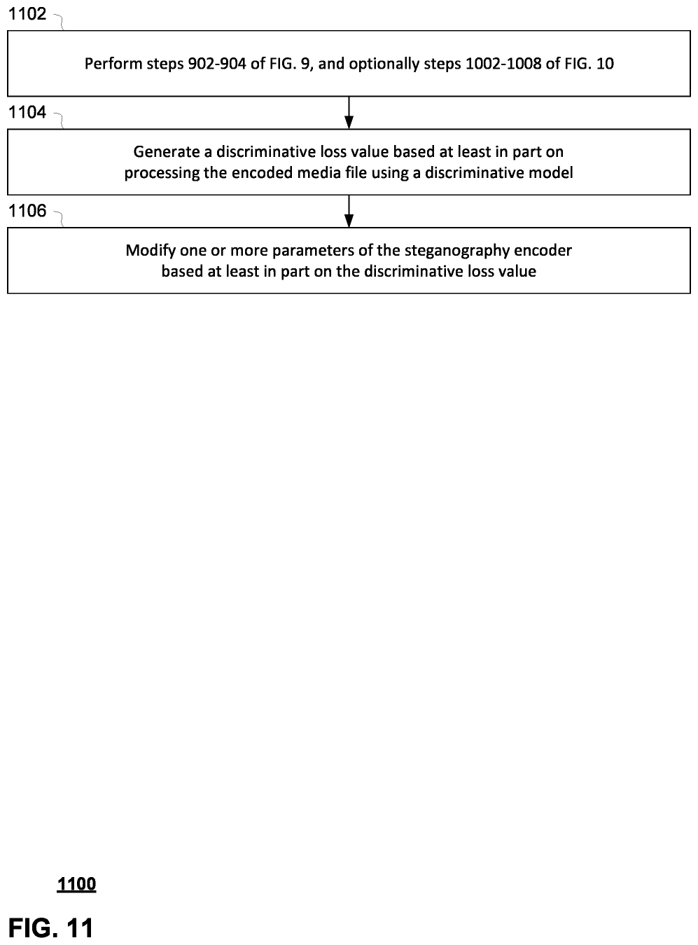

FIG. 9 sets forth an exemplary method 900 for generating a synthetically generated media file and encoding it using steganography, in accordance with aspects of the disclosure.

In step 902, a processing system (e.g., processing system 102) generates a synthetically generated media file based at least in part on first data using a generative model. This may be done in any suitable way. Thus, the generative model may be any suitable generative model, including any of the options described above with respect to generative model 304 of FIG. 3 and model 404 of FIG. 4. Likewise, the first data may include all or a subset of the data used by the generative model to generate the synthetically generated media file, and may be any suitable type of data, including any of the options described above with respect to source data 302 of FIG. 3 and source data 402 of FIG. 4. Further, the synthetically generated media file may be any suitable type, including any of the options described above with respect to synthetically generated media file 306 of FIG. 3.

In step 904, the processing system encodes second data into the synthetically generated media file using steganography to generate an encoded media file, the second data being based at least in part on the first data. This encoding may be applied by the generative model (e.g., as described above with respect to model 404 of FIG. 4) or by a dedicated steganography encoder (e.g., as described above with respect to steganography encoder 308 of FIG. 3 or steganography encoder 506 of FIG. 5). In either case, the encoding may be performed in any suitable way, including any of the options described above with respect to the steganography encoder 308 of FIG. 3, the steganography encoder incorporated into model 404 of FIG. 4, and the steganography encoder 506 of FIG. 5. In addition, the second data may be based on the first data in any suitable way, including the ways discussed above in which metadata 312 may be based on the source data 302 of FIG. 3 (and in which metadata 408 may be based on source data 402, and in which metadata 510 may be based on data 504).

FIG. 10 sets forth an exemplary method 1000 that expands on the exemplary method of FIG. 9 to generate an accuracy loss value and train a steganography encoder and/or steganography decoder based on the accuracy loss value, in accordance with aspects of the disclosure. Accordingly, step 1002 assumes that steps 902-904 of FIG. 9 will have been performed.

In step 1004, the processing system (e.g., processing system 102) processes the encoded media file (generated in step 904 of FIG. 9) using a steganography decoder to generate decoded data. This may be done in any suitable way. Thus, the steganography decoder may be any suitable type, including any of the options described above with respect to steganography decoder 602 of FIGS. 6A-C and 8A-C. Likewise, the decoded data may be any data derived from the encoded media file by the steganography decoder, as described above with respect to decoded data 604 of FIGS. 6A-C and 8A-C.

In step 1006, the processing system generates an accuracy loss value based at least in part on the second data and the decoded data. The processing system may use the second data and the decoded data to generate this accuracy loss value in any suitable way, including any of the options described above with respect to the generation of accuracy loss value 606 of FIGS. 6A-C and 8A-C.

In step 1008, the processing system modifies one or more parameters of the steganography encoder and/or the steganography decoder based at least in part on the accuracy loss value. In that regard, modifying one or more parameters of the steganography encoder may involve: (a) where the generative model is configured to apply the encoding to the synthetically generated media file (e.g., as described above with respect to model 404 of FIG. 4), modifying one or more parameters of the generative model; or (b) where a dedicated steganography encoder is used to apply the encoding to the synthetically generated media file (e.g., as described above with respect to steganography encoder 308 of FIG. 3 or steganography encoder 506 of FIG. 5), modifying one or more parameters of that dedicated steganography encoder.

The processing system may be configured to modify the one or more parameters based on the accuracy loss value in any suitable way, and at any suitable interval. Thus, in some aspects of the technology, the processing system may be configured to conduct a back-propagation step in which it modifies the one or more parameters of the steganography encoder and/or steganography decoder every time an accuracy loss value is generated. Likewise, in some aspects, the processing system may be configured to wait until a predetermined number of accuracy loss values have been generated, combine those values into an aggregate accuracy loss value (e.g., by summing or averaging the multiple accuracy loss values), and modify the one or more parameters of the steganography encoder and/or steganography decoder based on that aggregate accuracy loss value.

FIG. 11 sets forth an exemplary method 1100 that may be performed after the exemplary methods of FIG. 9 or FIG. 10 to generate a discriminative loss value and train a steganography encoder based on the discriminative loss value, in accordance with aspects of the disclosure. Accordingly, step 1102 assumes that at least steps 902-904 of FIG. 9 will have been performed, and that steps 1002-1008 of FIG. 10 may also have been performed.

In step 1104, the processing system (e.g., processing system 102) generates a discriminative loss value based at least in part on processing the encoded media file using a discriminative model. This may be done in any suitable way. Thus, the discriminative model may be any suitable type, including any of the options described above with respect to discriminative model 802 of FIGS. 8A-C. Likewise, the discriminative loss value may be generated directly by the discriminative model based on the encoded media file, or the discriminative model may process the encoded media file to generate an output (e.g., a score or probability that the encoded media file is real, a classification of “real” or “fake,” etc.) based on which the processing system then generates the discriminative loss value. Further, the discriminative loss value may be generated based on any suitable paradigm, including any of the options described above with respect to discriminative loss value 804 of FIGS. 8A-C.

In step 1106, the processing system modifies one or more parameters of the steganography encoder based at least in part on the discriminative loss value. Here as well, modifying one or more parameters of the steganography encoder may involve: (a) where the generative model is configured to apply the encoding to the synthetically generated media file (e.g., as described above with respect to model 404 of FIG. 4), modifying one or more parameters of the generative model; or (b) where a dedicated steganography encoder is used to apply the encoding to the synthetically generated media file (e.g., as described above with respect to steganography encoder 308 of FIG. 3 or steganography encoder 506 of FIG. 5), modifying one or more parameters of that dedicated steganography encoder.

The processing system may be configured to modify the one or more parameters based on the discriminative loss value in any suitable way, and at any suitable interval. Thus, in some aspects of the technology, the processing system may be configured to conduct a back-propagation step in which it modifies the one or more parameters of the steganography encoder every time a discriminative loss value is generated. Likewise, in some aspects, the processing system may be configured to wait until a predetermined number of discriminative loss values have been generated, combine those values into an aggregate discriminative loss value (e.g., by summing or averaging the multiple discriminative loss values), and modify the one or more parameters of the steganography encoder based on that aggregate discriminative loss value.

Further, where steps 1002-1008 of FIG. 10 have also been performed, the accuracy loss value generated in step 1006 of FIG. 10 and the discriminative loss value generated in step 1104 of FIG. 11 may be combined in any suitable way (e.g., summed, averaged, summed in a weighted manner, etc.) to generate a combined loss value on which the one or more parameters of the utility are modified. In such a case, the modification steps 1008 of FIG. 10 and 1106 of FIG. 11 may be performed together as a single back-propagation step based on the combined loss value. Moreover, where a combined loss value is employed, the processing system may be configured to conduct a back-propagation step in which it modifies the one or more parameters of the generative model or the steganography encoder based on a combined loss value every time a pair of accuracy loss and discriminative loss values is generated. Likewise, the processing system may be configured to wait until a predetermined number of accuracy loss values and discriminative loss values have been generated, combine those values into an aggregate loss value (e.g., by summing or averaging the multiple accuracy loss values and discriminative loss values), and modify the one or more parameters of the generative model or the steganography encoder based on that aggregate loss value.

FIG. 12 sets forth an exemplary method 1200 for encoding a preexisting media file using steganography, generating an accuracy loss value, and training a steganography encoder and/or steganography decoder based on the accuracy loss value, in accordance with aspects of the disclosure.

In step 1202, a processing system (e.g., processing system 102) encodes first data into a media file using a steganography encoder to generate an encoded media file. This media file may be of any suitable type (e.g., audio, image, video, etc.), and may have been generated in any suitable way (e.g., synthetically generated, human-generated, etc.), including any of the options discussed above with respect to media file 502 of FIG. 5. Likewise, in the example of FIG. 12, the first data may be any data related and/or relevant to the media file, including any of the options described above with respect to data 502 or metadata 510 of FIG. 5. Further, where the media file includes synthetically generated content, the first data may include any of the information described above with respect to source data 302 and 402, or metadata 312 and 408, of FIGS. 3 and 4. In all cases, the steganography encoder may be configured to encode the media file in any suitable way, including any of the options described above with respect to the steganography encoder 308 of FIG. 3 and the steganography encoder 506 of FIG. 5.

In step 1204, the processing system processes the media file using a steganography decoder to generate decoded data. This step may be performed in any suitable way, as described above with respect to step 1004 of FIG. 10. Thus, here as well, the steganography decoder may be any suitable type, including any of the options described above with respect to steganography decoder 602 of FIGS. 6A-C and 8A-C. Likewise, the decoded data may be any data derived from the encoded media file by the steganography decoder, as described above with respect to decoded data 604 of FIGS. 6A-C and 8A-C.

In step 1206, the processing system generates an accuracy loss value based at least in part on the first data and the decoded data. As with step 1006 of FIG. 10, the processing system may use the first data and the decoded data to generate this accuracy loss value in any suitable way, including any of the options described above with respect to the generation of accuracy loss value 606 of FIGS. 6A-C and 8A-C.

In step 1208, the processing system modifies one or more parameters of the steganography encoder and/or the steganography decoder based at least in part on the accuracy loss value. As with step 1008 of FIG. 10, the processing system may be configured to modify the one or more parameters based on the accuracy loss value in any suitable way, and at any suitable interval. Thus, in some aspects of the technology, the processing system may be configured to conduct a back-propagation step in which it modifies the one or more parameters of the steganography encoder and/or the steganography decoder every time an accuracy loss value is generated. Likewise, in some aspects, the processing system may be configured to wait until a predetermined number of accuracy loss values have been generated, combine those values into an aggregate accuracy loss value (e.g., by summing or averaging the multiple accuracy loss values), and modify the one or more parameters of the steganography encoder and/or the steganography decoder based on that aggregate accuracy loss value.

FIG. 13 sets forth an exemplary method 1300 that may be performed after step 1202 or step 1208 of FIG. 12 to generate a discriminative loss value and train a steganography encoder based on the discriminative loss value, in accordance with aspects of the disclosure. Accordingly, step 1302 assumes that at least step 1202 of FIG. 12 will have been performed, and that steps 1204-1208 of FIG. 12 may also have been performed.

In step 1304, the processing system (e.g., processing system 102) generates a discriminative loss value based at least in part on processing the encoded media file using a discriminative model. This step may be performed in any suitable way, as described above with respect to step 1104 of FIG. 11. Thus, here as well, the discriminative model may be any suitable type, including any of the options described above with respect to discriminative model 802 of FIGS. 8A-C. Likewise, the discriminative loss value may be generated directly by the discriminative model based on the encoded media file, or the discriminative model may process the encoded media file to generate an output (e.g., a score or probability that the encoded media file is real, a classification of “real” or “fake,” etc.) based on which the processing system then generates the discriminative loss value. Further, the discriminative loss value may be generated based on any suitable paradigm, including any of the options described above with respect to discriminative loss value 804 of FIGS. 8A-C.

In step 1306, the processing system modifies one or more parameters of the steganography encoder based at least in part on the discriminative loss value. As with step 1106 of FIG. 11, the processing system may be configured to modify the one or more parameters based on the discriminative loss value in any suitable way, and at any suitable interval. Thus, in some aspects of the technology, the processing system may be configured to conduct a back-propagation step in which it modifies the one or more parameters of the steganography encoder every time a discriminative loss value is generated. Likewise, in some aspects, the processing system may be configured to wait until a predetermined number of discriminative loss values have been generated, combine those values into an aggregate discriminative loss value (e.g., by summing or averaging the multiple discriminative loss values), and modify the one or more parameters of the steganography encoder based on that aggregate discriminative loss value.

Further, where steps 1204-1208 of FIG. 12 have also been performed, the accuracy loss value generated in step 1206 of FIG. 12 and the discriminative loss value generated in step 1304 of FIG. 13 may be combined in any suitable way (e.g., in a weighted manner) to generate a combined loss value on which the one or more parameters of the steganography encoder are modified. In such a case, the modification steps 1208 of FIG. 12 and 1306 of FIG. 13 may be performed together as a single back-propagation step based on the combined loss value. Moreover, where a combined loss value is employed, the processing system may be configured to conduct a back-propagation step in which it modifies the one or more parameters of the steganography encoder based on a combined loss value every time a pair of accuracy loss and discriminative loss values is generated. Likewise, the processing system may be configured to wait until a predetermined number of accuracy loss values and discriminative loss values have been generated, combine those values into an aggregate loss value (e.g., by summing or averaging the multiple accuracy loss values and discriminative loss values), and modify the one or more parameters of the steganography encoder based on that aggregate loss value.

FIG. 14 sets forth an exemplary method 1400 for generating a synthetically generated media file, generating a first accuracy loss value, and training a generative model based on the first accuracy loss value, in accordance with aspects of the disclosure.

In step 1402, a processing system (e.g., processing system 102) generates a synthetically generated media file based at least in part on first data using a generative model. As with step 902 of FIG. 9, this may be done in any suitable way. Thus, the generative model may be any suitable generative model, including any of the options described above with respect to generative model 304 of FIG. 3 and model 404 of FIG. 4. Likewise, the first data may include all or a subset of the data used by the generative model to generate the synthetically generated media file, and may be any suitable type of data, including any of the options described above with respect to source data 302 of FIG. 3 and source data 402 of FIG. 4. Further, the synthetically generated media file may be any suitable type, including any of the options described above with respect to synthetically generated media file 306 of FIG. 3.

In step 1404, the processing system processes the synthetically generated media file using an interpretive model to generate first interpreted data. This may be done in any suitable way. Thus, the interpretive model may be any suitable type of model configured to interpret the content of a particular type of media file (e.g., audio, image, video, rendered text, etc.) in order to generate first interpreted data, including any of the options described above with respect to interpretive model 702 of FIG. 7. Likewise, the first interpreted data may be any data derived from the synthetically generated media file by the interpretive model, as described above with respect to interpreted data 704 of FIG. 7.

In step 1406, the processing system generates a first accuracy loss value based at least in part on the first data and the first interpreted data. The processing system may use the first data and the first interpreted data to generate this first accuracy loss value in any suitable way, including any of the options described above with respect to the generation of accuracy loss value 706 of FIG. 7.

In step 1408, the processing system modifies one or more parameters of the generative model based at least in part on the first accuracy loss value. As discussed above with respect to FIG. 7, the processing system may be configured to modify the one or more parameters based on the first accuracy loss value in any suitable way, and at any suitable interval. Thus, in some aspects of the technology, the processing system may be configured to conduct a back-propagation step in which it modifies the one or more parameters of the generative model every time an accuracy loss value is generated. Likewise, in some aspects, the processing system may be configured to wait until a predetermined number of accuracy loss values have been generated, combine those values into an aggregate accuracy loss value (e.g., by summing or averaging the multiple accuracy loss values), and modify the one or more parameters of the generative model based on that aggregate accuracy loss value.

FIG. 15 sets forth an exemplary method 1500 that may be performed after steps 1402-1406 of FIG. 14 to identify second data to be encoded into the synthetically generated media file, generate a second accuracy loss value, and train the generative model and/or the steganography encoder based on the first and second accuracy loss values, in accordance with aspects of the disclosure. Accordingly, step 1502 assumes that steps 1402-1406 of FIG. 14 will have been performed.

In step 1504, the processing system (e.g., processing system 102) identifies a difference between the first data and the first interpreted data. The processing system may identify a difference between the first data and the first interpreted data in any suitable way. Thus, in some aspects of the technology, the processing system may be configured to compare the content of the first data to the content of the first interpreted data to identify a difference between them. For example, where the first data and the first interpreted data are in text format, the processing system may compare the text of the first data to the text of the first interpreted data to identify one or more words or characters that differ. Likewise, in some aspects of the technology, the processing system may be configured to identify a difference between the first data and the first interpreted data indirectly, such as by comparing a vector based on the first data to a vector based on the first interpreted data. For example, where the interpretive model is configured to output a vector based on the synthetically generated media file (e.g., a vector representing the interpretive model's classification of an object depicted in a synthetically generated image), the processing system may be configured to likewise generate a vector based on the first data (e.g., using a learned embedding function) so that it may be compared to the output of the interpretive model to identify any differences between how the first data and the first interpreted data would be classified.

In step 1506, the processing system encodes second data into the synthetically generated media file using a steganography encoder to generate an encoded media file, the second data being based at least in part on the difference identified in step 1504. Here as well, this encoding may be applied by a steganography encoder that is part of the generative model (e.g., as described above with respect to model 404 of FIG. 4) or by a dedicated steganography encoder (e.g., as described above with respect to steganography encoder 308 of FIG. 3 or steganography encoder 506 of FIG. 5). Likewise, the encoding may be performed in any suitable way, including any of the options described above with respect to the steganography encoder 308 of FIG. 3, the steganography encoder incorporated into model 404 of FIG. 4, and the steganography encoder 506 of FIG. 5.

In the example of FIG. 15, the second data may be based on the identified difference in any suitable way. Thus, in some aspects of the technology, the second data may simply be the identified difference or a portion thereof. For example, where the first data and the first interpreted data are in text format, the second data may simply be one or more words or characters that differ between the first data and the first interpreted data. Likewise, where the interpretive model is configured to output a vector based on the synthetically generated media file (e.g., a vector representing the interpretive model's classification of an object depicted in a synthetically generated image), the second data may be a calculated difference (e.g., dot-product, subtraction) between the vector output of the interpretive model and a vector based on the first data (e.g., a vector generated by processing the first data using a learned embedding function).

In addition, in some aspects of the technology, the second data may simply be related to the identified difference. For example, where the interpretive model is configured to output a vector based on the synthetically generated media file (e.g., a vector representing the interpretive model's classification of an object depicted in a synthetically generated image), the second data may be a vector representing a prediction of the correct classification (e.g., the classification produced by applying a learned embedding function to the first data).

In step 1508, the processing system processes the encoded media file using the interpretive model (used previously in step 1404 of FIG. 14) to generate second interpreted data. As discussed above with respect to step 1404 of FIG. 14, this may be done in any suitable way, and the second interpreted data may be any data derived from the encoded media file by the interpretive model, as described above with respect to interpreted data 704 of FIG. 7.

In step 1510, the processing system generates a second accuracy loss value based at least in part on the first data and the second interpreted data. Here as well, the processing system may use the first data and the second interpreted data to generate this second accuracy loss value in any suitable way, including any of the options described above with respect to the generation of accuracy loss value 706 of FIG. 7.

In step 1512, the processing system modifies one or more parameters of the generative model and/or the steganography encoder based at least in part on the first accuracy loss value and the second accuracy loss value. Here again, as discussed above with respect to FIG. 7, the processing system may be configured to modify the one or more parameters of the generative model and/or the steganography encoder based on the first accuracy loss value and the second accuracy loss value in any suitable way. For example, in some aspects of the technology, the processing system may be configured to use the second accuracy loss value to modify one or more parameters of the generative model and/or the steganography encoder only if the second accuracy loss value is lower than the first accuracy loss value (or is lower by a predetermined threshold), and to otherwise use the first accuracy loss value to modify one or more parameters of the generative model and/or the steganography encoder. Likewise, in some aspects of the technology, the processing system may be configured to use the first accuracy loss value to modify one or more parameters of the generative model (e.g., to train the generative model to generate media files in a way that is more likely to be correctly interpreted by the interpretive model), and to use the second accuracy loss value to modify one or more parameters of the steganography encoder (e.g., to train the steganography encoder to encode hints into the media files in similar circumstances). Further, in some aspects of the technology, the processing system may be configured to use the first accuracy loss value to modify one or more parameters of the generative model (e.g., to train the generative model to generate media files in a way that is more likely to be correctly interpreted by the interpretive model), and, if the second accuracy loss value is lower than the first accuracy loss value (or is lower by a predetermined threshold), to use the second accuracy loss value to modify one or more parameters of the generative model (e.g., to train the generative model to invoke the steganography encoder to encode hints into the media files in similar circumstances).

In addition, the processing system may be configured to modify the one or more parameters of the generative model and/or the steganography encoder based on the first accuracy loss value and the second accuracy loss value at any suitable interval. Thus, in some aspects of the technology, the processing system may be configured to conduct a back-propagation step in which it modifies the one or more parameters of the generative model and/or the steganography encoder every time a pair of first and second accuracy loss values are generated. Likewise, in some aspects, the processing system may be configured to wait until a predetermined number of accuracy loss value pairs have been generated, use those accuracy loss value pairs to generate one or more aggregate accuracy loss values (e.g., by summing or averaging all of the first accuracy loss values to generate a first aggregated accuracy loss value, and summing or averaging all of the second loss values to generate a second aggregated accuracy loss value, etc.), and modify the one or more parameters of the generative model based on those aggregate accuracy loss values.

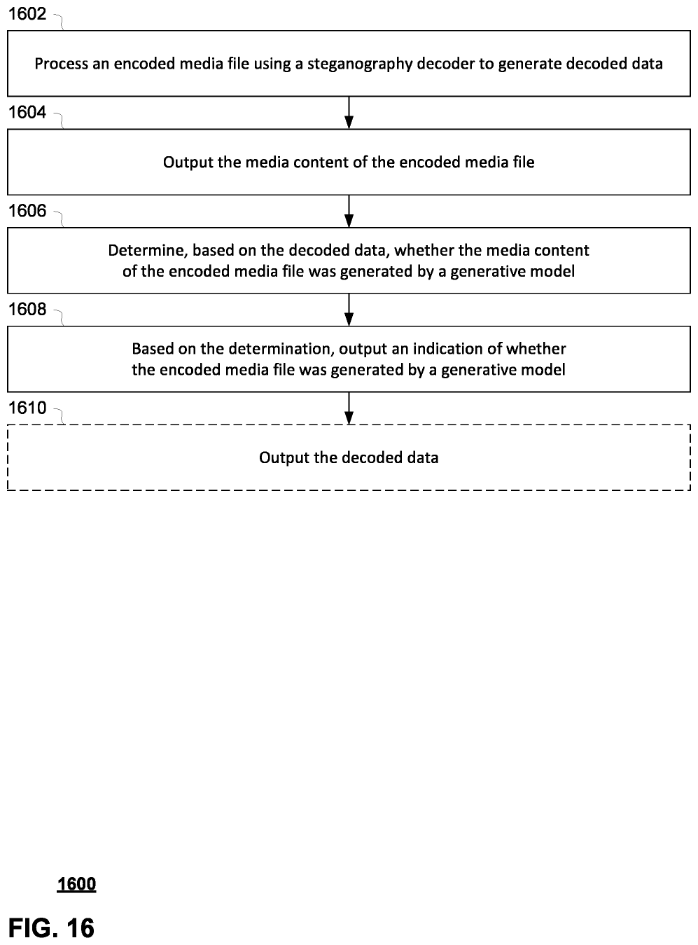

FIG. 16 sets forth an exemplary method 1600 for processing an encoded media file and outputting its associated media and an indication of how it was generated, in accordance with aspects of the disclosure.

In step 1602, a processing system (e.g., processing system 102) processes an encoded media file using a steganography decoder to generate decoded data. As discussed above with respect to step 1004 of FIG. 10, this may be done in any suitable way. Thus, the steganography decoder may be any suitable type, including any of the options described above with respect to steganography decoder 602 of FIGS. 6A-C and 8A-C. Likewise, the decoded data may be any data derived from the encoded media file by the steganography decoder, as described above with respect to decoded data 604 of FIGS. 6A-C and 8A-C.

In step 1604, the processing system outputs the media content of the encoded media file. This may be done using any suitable utility and/or hardware for displaying or playing the type of media within the encoded media file. For example, if the content of the encoded media file includes an image, the processing system may output the image by providing an instruction for the image to be displayed on a monitor, printer, or other type of display device. Likewise, if the content of the encoded media file includes a video, the processing system may output the video by providing an instruction for visual data of the video to be displayed on a monitor or other type of display device and/or for audio data of the video to be played on a speaker or other audio output device. Similarly, if the content of the encoded media file includes audio data, the processing system may output the audio data by providing an instruction for the audio data to be played on a speaker or other audio output device, and/or by instructing that a visualization of the audio data's content (e.g., a graph of the audio data's waveform) be displayed on a monitor, printer, or other type of display device.

In step 1606, the processing system determines whether the media content of the encoded media file was generated by a generative model based on the decoded data. The processing system may use the decoded data to make this determination in any suitable way. Thus, in some aspects of the technology, the processing system may be configured to determine that the media content of the encoded media file was generated by a generative model based solely on the fact that the steganography decoder was able to extract decoded data from the encoded media file. Likewise, in some aspects of the technology, the processing system may be configured to determine whether the media content of the encoded media file was generated by a generative model based on the content of the decoded data. For example, in some aspects of the technology, the decoded data may include an indication that the media content of the encoded media file was generated by a generative model.

In step 1608, based on the determination of step 1606, the processing system outputs an indication of whether the encoded media file was generated by a generative model. Here as well, the processing system may output this indication using any suitable utility and/or hardware. For example, the processing system may output a message indicating that the encoded media file was or was not generated by a generative model by providing an instruction for the message to be displayed on a monitor, printer, or other type of display device, or by providing an instruction for a synthesized reading of the message to be played on a speaker or other audio output device. Likewise, in some aspects of the technology, the processing system may output any other suitable type of indication of its determination, such as by providing an instruction for an icon or image to be displayed on a display device, for all or a portion of a screen to blink, for a sound to be played on a speaker or other audio output device, etc. As will be understood, in some aspects of the technology, the processing system may be configured to only output this indication based on certain preconditions (e.g., in response to a request from a user).

In step 1610, the processing system outputs the decoded data. Step 1610 is an optional step within exemplary method 1600, and may be performed at any suitable time relative to the other steps. For example, the processing system may output the decoded data before, after, or at the same time as it outputs the media content of the media file (step 1604). Likewise, the processing system may output the decoded data before, after, or at the same time as it outputs the indication of whether the encoded media file was generated by a generative model (step 1608). Here as well, the processing system may output the decoded data using any suitable utility and/or hardware. For example, if the decoded data is a sequence of text (e.g., close-captioning content of a video file, text used to synthetically generate speech in a video or audio file, etc.), the processing system may output the sequence of text by providing an instruction for the text to be displayed on a monitor or other type of display device. In addition, in some aspects of the technology, the processing system may be configured to only output the decoded data based on certain preconditions (e.g., in response to a request from a user).

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of exemplary systems and methods should be taken by way of illustration rather than by way of limitation of the subject matter defined by the claims. In addition, the provision of the examples described herein, as well as clauses phrased as “such as,” “including,” “comprising,” and the like, should not be interpreted as limiting the subject matter of the claims to the specific examples; rather, the examples are intended to illustrate only some of the many possible embodiments. Further, the same reference numbers in different drawings can identify the same or similar elements.

1. A computer-implemented training method, comprising:
generating, using one or more processors of a processing system, a synthetically generated media file based at least in part on first data using a generative model;
encoding, using the one or more processors, second data into the synthetically generated media file using a steganography encoder to generate an encoded media file, the second data being based at least in part on the first data;
processing, using the one or more processors, the encoded media file using a steganography decoder to generate decoded data;
generating, using the one or more processors, an accuracy loss value based at least in part on the second data and the decoded data; and
modifying, using the one or more processors, one or both of:
one or more parameters of the steganography encoder, based at least in part on the accuracy loss value; or
one or more parameters of the steganography decoder, based at least in part on the accuracy loss value.

2. The method of claim 1, further comprising:
generating, using the one or more processors, a discriminative loss value based at least in part on processing the encoded media file using a discriminative model; and
modifying, using the one or more processors, one or more parameters of the steganography encoder based at least in part on the discriminative loss value.

3. The method of claim 1, wherein the steganography encoder is a part of the generative model.

4. The method of claim 1, wherein the first data is a text sequence, the generative model is a text-to-speech model, and the synthetically generated media file is an audio file including synthesized speech generated by the text-to-speech model based at least in part on the text sequence.

5-7. (canceled)

8. A computer-implemented training method, comprising:
generating, using one or more processors of a processing system, a synthetically generated media file based at least in part on first data using a generative model;
encoding, using the one or more processors, second data into the synthetically generated media file using a steganography encoder to generate an encoded media file, the second data being based at least in part on the first data;
generating, using the one or more processors, a discriminative loss value based at least in part on processing the encoded media file using a discriminative model; and
modifying, using the one or more processors, one or more parameters of the steganography encoder based at least in part on the discriminative loss value.

9. The method of claim 8, wherein the first data is a text sequence, the generative model is a text-to-speech model, and the synthetically generated media file is an audio file including synthesized speech generated by the text-to-speech model based at least in part on the text sequence.

10. The method of claim 9, wherein encoding the second data into the synthetically generated media file using the steganography encoder to generate the encoded media file comprises:
encoding the text sequence into the encoded media file;
encoding a tokenized version of the text sequence into the encoded media file; or
encoding a vector embedding based on the text sequence into the encoded media file.

11-12. (canceled)

13. A computer-implemented training method, comprising:
encoding, using one or more processors of a processing system, first data into a media file using a steganography encoder to generate an encoded media file;
processing, using the one or more processors, the encoded media file using a steganography decoder to generate decoded data;
generating, using the one or more processors, an accuracy loss value based at least in part on the first data and the decoded data; and
modifying, using the one or more processors, one or both of:
one or more parameters of the steganography encoder, based at least in part on the accuracy loss value; or
one or more parameters of the steganography decoder, based at least in part on the accuracy loss value.

14. The method of claim 13, further comprising:
generating, using the one or more processors, a discriminative loss value based at least in part on processing the encoded media file using a discriminative model; and
modifying, using the one or more processors, one or more parameters of the steganography encoder based at least in part on the discriminative loss value.

15. The method of claim 13, wherein the media file is a synthetically generated media file generated by a generative model.

16-18. (canceled)

19. The method of claim 13, wherein the media file contains speech, and encoding the first data into the media file using the steganography encoder to generate the encoded media file comprises:
encoding a text sequence into the encoded media file, the text sequence including a transcript or a translation of at least a portion of the speech;
encoding a tokenized version of a text sequence into the encoded media file, the text sequence including a transcript or a translation of at least a portion of the speech; or
encoding a vector embedding based on a text sequence into the encoded media file, the text sequence including a transcript or a translation of at least a portion of the speech.

20-21. (canceled)

22. A computer-implemented training method, comprising:
generating, using one or more processors of a processing system, a synthetically generated media file based at least in part on first data using a generative model;
processing, using the one or more processors, the synthetically generated media file using an interpretive model to generate first interpreted data;
generating, using the one or more processors, a first accuracy loss value based at least in part on the first data and the first interpreted data; and
modifying, using the one or more processors, one or more parameters of the generative model based at least in part on the first accuracy loss value.

23. The method of claim 22, wherein the first data is a text sequence, the generative model is a text-to-speech model, the synthetically generated media file is an audio file including synthesized speech generated by the text-to-speech model based at least in part on the text sequence, and the interpretive model is an automatic speech recognition model.

24. The method of claim 22, further comprising:
identifying, using the one or more processors, a difference between the first data and the first interpreted data;
encoding, using the one or more processors, second data into the synthetically generated media file using a steganography encoder to generate an encoded media file, the second data being based at least in part on the identified difference;
processing, using the one or more processors, the encoded media file using the interpretive model to generate second interpreted data;
generating, using the one or more processors, a second accuracy loss value based at least in part on the first data and the second interpreted data; and
modifying, using the one or more processors, one or more parameters of the steganography encoder based at least in part on the first accuracy loss value and the second accuracy loss value.

25-26. (canceled)

27. The method of claim 24, wherein:
the first data is a first text sequence, the first interpreted data is a second text sequence, and the identified difference comprises one or more words or characters that differ between the first text sequence and the second text sequence; and
encoding the second data into the synthetically generated media file using the steganography encoder to generate the encoded media file comprises:
encoding the one or more words or characters into the encoded media file;
encoding a tokenized version of the one or more words or characters into the encoded media file; or
encoding a vector embedding based on the one or more words into the encoded media file.

28-30. (canceled)

31. A computer-implemented method of outputting a media file, comprising:
processing, using one or more processors of a processing system, an encoded media file using a steganography decoder to generate decoded data;
outputting, using the one or more processors, media content of the encoded media file;
determining, using the one or more processors, based on the decoded data, whether the media content of the encoded media file was generated by a generative model; and
based on the determination, outputting, using the one or more processors, an indication of whether the encoded media file was generated by a generative model.

32. The method of claim 31, wherein outputting the indication of whether the encoded media file was generated by a generative model is performed in response to receiving an input from a user.

33. The method of claim 31, further comprising outputting, using the one or more processors, the decoded data.

34-35. (canceled)

36. A computer-implemented media generation method, comprising:
generating, using one or more processors of a processing system, a synthetically generated media file based at least in part on first data using a generative model; and
encoding, using the one or more processors, second data into the synthetically generated media file using a steganography encoder to generate an encoded media file, the second data being based at least in part on the first data.

37. The method of claim 36, wherein the steganography encoder is a part of the generative model.

38. The method of claim 36, wherein:
the first data is a text sequence, the generative model is a text-to-speech model, and the synthetically generated media file is an audio file including synthesized speech generated by the text-to-speech model based at least in part on the text sequence; and
encoding the second data into the synthetically generated media file using the steganography encoder to generate the encoded media file comprises:
encoding one or more words of the text sequence into the encoded media file;
encoding a tokenized version of one or more words of the text sequence into the encoded media file;
encoding a vector embedding based on one or more words of the text sequence into the encoded media file; or
encoding a vector into the encoded media file, the vector representing a classification generated by an interpretive model based on the text sequence.

39-43. (canceled)
